(19) United States
(12) Patent Application Publication
(10) Pub. No.: US 2013/0254495 A1
(43) Pub. Date: Sep. 26, 2013

(54) MEMORY SYSTEM

(71) Applicant: SAMSUNG ELECTRONICS CO., LTD., Suwon-si (KR)

(72) Inventors: Jeong-Kyoum Kim, Seoul (KR); Jung-Hwan Choi, Hwaseong-si (KR); Seok-Hun Hyun, Seongnam-si (KR)

(73) Assignee: Samsung Electronics Co., Ltd., Suwon-si (KR)

(21) Appl. No.: 13/804,044

(22) Filed: Mar. 14, 2013

(30) Foreign Application Priority Data
Mar. 23, 2012 (KR) 10-2012-0029964

(51) Int. Cl. G06F 13/16

(52) U.S. Cl. CPC G06F 13/1663
USPC 711/150

(57) ABSTRACT

A memory system includes a memory controller, and first through fourth memory modules. The first memory module is directly connected to the memory controller through a first memory bus and exchanges first data with the memory controller through the first memory bus. The second memory module is directly connected to the memory controller through a second memory bus and exchanges second data with the memory controller through the second memory bus. The third memory module is connected to the first memory module through a third memory bus and exchanges the first data with the memory controller through the first and third memory buses. The fourth memory module is connected to the second memory module through a fourth memory bus and exchanges the second data with the memory controller through the second and fourth memory buses.

### CROSS-REFERENCE TO RELATED APPLICATIONS

This application claims priority under 35 USC §119 to Korean Patent Application No. 2012-0029964, filed on Mar. 23, 2012 in the Korean Intellectual Property Office (KIPO), the contents of which are herein incorporated by reference in their entirety.

### BACKGROUND

Example embodiments relate generally to semiconductor memory devices, and more particularly to memory systems including volatile memory devices.

Semiconductor memory devices may be respectively categorized as nonvolatile or volatile in nature according to their ability, or lack of ability, to retain stored data in the absence of applied power. The volatile memory devices are widely used as main memories in various computing systems. As the speed of operation of the computing system has increased, high-speed access and high-capacity data storage in the main memory (e.g., the volatile memory device) has been required. The main memory in the computing system may be implemented as a memory system that includes a memory controller and a plurality of memory modules. In the memory system, the memory controller may be connected to the plurality of memory modules in multi-drop methods or point-to-point methods.

### SUMMARY

Accordingly, the disclosed embodiments are provided to substantially obviate one or more problems due to limitations and disadvantages of the related art.

Some example embodiments provide a memory system capable of increasing data storage capacity with a point-to-point connection.

According to example embodiments, a memory system includes a memory controller, a first memory module, a second memory module, a third memory module and a fourth memory module. The first memory module is directly connected to the memory controller through a first memory bus and exchanges first data of a plurality of data with the memory controller through the first memory bus. The second memory module is directly connected to the memory controller through a second memory bus and exchanges second data of the plurality of data with the memory controller through the second memory bus. The second data is different from the first data. The third memory module is connected to the first memory module through a third memory bus and exchanges the first data with the memory controller through the first memory bus and the third memory bus. The fourth memory module is connected to the second memory module through a fourth memory bus and exchanges the second data with the memory controller through the second memory bus and the fourth memory bus.

In an example embodiment, one of the first and third memory modules may be selected as a first selected memory module based on a selection signal. One of the second and fourth memory modules may be selected as a second selected memory module based on the selection signal. The memory controller may store first write data of write data in the first selected memory module and may store second write data of the write data in the second selected memory module during a write operation mode. The second write data may be different from the first write data. The memory controller may read first read data of read data from the first selected memory module and may read second read data of the read data from the second selected memory module during a read mode. The second read data may be different from the first read data.

A first unselected memory module and a second unselected memory module may be disabled based on the selection signal. The first unselected memory module may be the other one of the first and third memory modules, the second unselected memory module may be the other one of the second and fourth memory modules.

In an example embodiment, the first memory module may include a plurality of first data input/output (I/O) pins, a plurality of second data I/O pins and a volatile memory device. The plurality of first data I/O pins may be connected to the first memory bus. The plurality of second data I/O pins may be connected to the third memory bus. The volatile memory device may be connected to the plurality of first data I/O pins and the plurality of second data I/O pins. The volatile memory device may exchange the first data with the memory controller through the first bus and the plurality of first data I/O pins, or the first data may be transmitted from one of the memory controller and the third memory module to another one of the memory controller and the third memory module through the first memory bus, the plurality of first data I/O pins, the volatile memory device, the plurality of second data I/O pins and the third memory bus.

The first memory module may further include a plurality of data I/O buffer units. Each data I/O buffer unit may have a first path and a second path. A first path may indicate a path between one of the first data I/O pins and a memory core included in the volatile memory device. A second path may indicate a path between the one of the first data I/O pins and one of the second data I/O pins. One of the first path and the second path may be selectively enabled.

In an example embodiment, each data I/O buffer may include a first buffer unit, a second buffer unit, a third buffer unit and a path selection unit. The first buffer unit may be connected to the one of the first data I/O pins. The second buffer unit may be connected to the memory core. The third buffer unit may be connected to the one of the second data I/O pins. The path selection unit may connect one of the second buffer unit and the third buffer unit to the first buffer unit based on a selection signal.

Another one of the second buffer unit and the third buffer unit that is not connected to the first buffer unit may be disabled based on the selection signal.

In an example embodiment, a distance between the memory controller and the second memory module may be longer or shorter than a distance between the memory controller and the fourth memory module.

In an example embodiment, the memory system may further include a fifth memory module. The fifth memory module may be connected to the third memory module through a fifth memory bus, and may exchange the first data with the memory controller through the first memory bus, the third memory bus and the fifth memory bus.

In an example embodiment, the memory system may further include a sixth memory module. The sixth memory module may be connected to the fourth memory module through a sixth memory bus, and may exchange the second data with the memory controller through the second memory bus, the fourth memory bus and the sixth memory bus.

In an example embodiment, the memory system may further include a seventh memory module and an eighth memory module. The seventh memory module may be connected to the fifth memory module through a seventh memory bus, and may exchange the first data with the memory controller through the first memory bus, the third memory bus, the fifth memory bus and the seventh memory bus. The eighth memory module may be connected to the sixth memory module through an eighth memory bus, and may exchange the second data with the memory controller through the second memory bus, the fourth memory bus, the sixth memory bus and the eighth memory bus.

In an example embodiment, the memory system may further include a fifth memory module, a sixth memory module, a seventh memory module and an eighth memory module. The fifth memory module may be directly connected to the memory controller through a fifth memory bus, and may exchange third data of the plurality of data with the memory controller through the fifth memory bus. The third data may be different from the first data and the second data. The sixth memory module may be directly connected to the memory controller through a sixth memory bus, and may exchange fourth data of the plurality of data with the memory controller through the sixth memory bus. The fourth data may be different from the first data, the second data and the third data. The seventh memory module may be connected to the fifth memory module through a seventh memory bus, and may exchange the third data with the memory controller through the fifth memory bus and the seventh memory bus. The eighth memory module may be connected to the sixth memory module through an eighth memory bus, and may exchange the fourth data with the memory controller through the sixth memory bus and the eighth memory bus.

In an example embodiment, the memory controller and the first, second, third and fourth memory modules may be mounted on a base substrate. The first, second, third and fourth memory buses may be provided such that a plurality of data lines that are formed on the base substrate are selectively electrically opened or shorted.

According to other embodiments, a memory system includes a memory controller, a first memory bus, a second memory bus, a third memory bus and a fourth memory bus. The first memory bus connects the memory controller to a first memory module. First write data is transmitted to the first memory module through the first memory bus. The second memory bus connects the memory controller to a second memory module. Second write data is transmitted to the second memory module through the second memory bus. The second write data is different from the first write data, and the first write data and the second write data are simultaneously output from the memory controller. The third memory bus connects the first memory module to a third memory module. The first write data is transmitted to the third memory module through the first memory bus and the third memory bus. The fourth memory bus connects the second memory module to a fourth memory module. The second write data is transmitted to the fourth memory module through the second memory bus and the fourth memory bus.

In an example embodiment, first read data may be transmitted to the memory controller through the first memory bus when the first read data is stored in the first memory module. The first read data may be transmitted to the memory controller through the first memory bus and the third memory bus when the first read data is stored in the third memory module. Second read data may be transmitted to the memory controller through the second memory bus when the second read data is stored in the second memory module. The second read data may be transmitted to the memory controller through the second memory bus and the fourth memory bus when the second read data is stored in the fourth memory module. The second read data may be different from the first read data, and the memory controller may simultaneously receive the first read data and the second read data.

Accordingly, in the memory system according to example embodiments, the memory controller may be connected to the first and second memory modules in point-to-point methods, and the first and second memory modules may be connected to the third and fourth memory modules in the point-to-point methods, thereby having relatively high data storage capacity. In addition, the plurality of data may be divided into at least two data groups, the memory modules may be divided into at least two memory module groups, and each data group may be stored in or read from a selected memory module of each memory module group, thereby effectively storing or reading the plurality of data.

According to another embodiment, a memory system includes a controller, a first memory module, a first bus, a second memory module, and a second bus. The first memory module includes at least a first memory device having a first memory core. The first bus is between the controller and the first memory module. The second memory module includes at least a second memory device having a second memory core. The second bus is between the first memory module and the second memory module. The first bus is selectively electrically connected to the second bus, and the first bus is selectively electrically connected to the first memory core.

In one embodiment, the memory system includes a third memory module including at least a third memory device having a third memory core; a third bus between the controller and the third memory module; a fourth memory module including at least a fourth memory device having a fourth memory core; and a fourth bus between the third memory module and the fourth memory module.

The controller may be connected to each of the first memory module and the third memory module in a point-to-point manner; the first memory module may be connected to the second memory module in a point-to-point manner; and the third memory module may be connected to the fourth memory module in a point-to-point manner.

The controller may transmit data directly to the first memory module and transmit data directly to the third memory module; and the controller may transmit data to the second memory module through the first memory module, and transmit data to the fourth memory module through the third memory module.

In one embodiment, the memory system is further configured so that the controller transmits data directly to the first memory module and simultaneously transmits data directly to the third memory module, and the controller transmits data indirectly to the second memory module and simultaneously transmits data indirectly to the fourth memory module.

The memory system may be further configured so that the controller receives data directly from the first memory module and simultaneously receives data directly from the third memory module; and the controller receives data indirectly from the second memory module and simultaneously receives data indirectly from the fourth memory module.

### BRIEF DESCRIPTION OF THE DRAWINGS

Illustrative, non-limiting example embodiments will be more clearly understood from the following detailed description taken in conjunction with the accompanying drawings.

FIGS. 1A and 1B are diagrams illustrating a memory system according to example embodiments.

FIGS. 2A, 2B, 3A and 3B are diagrams for describing exemplary operations of the memory system of FIGS. 1A and 1B.

FIG. 4 is a diagram for describing an exemplary structure of the memory system of FIGS. 1A and 1B.

FIGS. 5A, 5B, 6A and 6B are tables for describing exemplary connections of the data I/O pins in the memory system of FIGS. 1A and 1B.

FIG. 7 is a diagram illustrating an example of a first memory module included in the memory system of FIGS. 1A and 1B.

FIG. 8 is a block diagram illustrating an example of a data I/O buffer unit included in the first memory module of FIG. 7.

FIGS. 9A and 9B are diagrams for describing exemplary operations of the data I/O buffer unit of FIG. 8.

FIG. 10 is a block diagram illustrating another example of the data I/O buffer unit included in the first memory module of FIG. 7.

FIGS. 11A, 11B and 11C are diagrams for describing modified exemplary structures of the memory system of FIGS. 1A and 1B.

FIGS. 12A and 12B are diagrams illustrating a memory system according to example embodiments.

FIGS. 13A and 13B are diagrams for describing exemplary operations of the memory system of FIGS. 12A and 12B.

FIG. 14 is a block diagram illustrating an example of a data I/O buffer unit included in a second memory module in FIGS. 12A and 12B.

FIGS. 15A and 15B are diagrams for describing exemplary operations of the data I/O buffer unit of FIG. 14.

FIGS. 16 and 17 are diagrams illustrating memory systems according to example embodiments.

FIGS. 18A and 18B are diagrams illustrating a memory system according to example embodiments.

FIG. 18C is a diagram for describing an exemplary structure of the memory system of FIGS. 18A and 18B.

FIGS. 19A and 19B are diagrams illustrating a memory system according to example embodiments.

FIG. 19C is a diagram for describing an exemplary structure of the memory system of FIGS. 19A and 19B.

FIGS. 20A, 20B, 20C and 20D are tables for describing exemplary connections of the data I/O pins in the memory system of FIGS. 19A and 19B.

FIG. 21 is a diagram illustrating a memory system according to example embodiments.

FIG. 22 is a block diagram illustrating a computing system according to example embodiments.

### DETAILED DESCRIPTION

Various example embodiments will be described more fully with reference to the accompanying drawings, in which embodiments are shown. This inventive concept may, however, be embodied in many different forms and should not be construed as limited to the embodiments set forth herein. Like reference numerals refer to like elements throughout this application.

It will be understood that, although the terms first, second, etc. may be used herein to describe various elements, these elements should not be limited by these terms. Unless indicated otherwise, these terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, or “on” another element, it can be directly connected or coupled to or on the other element or intervening elements may be present. In contrast, when an element is referred to as being “directly connected” or “directly coupled” to or “on” another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Embodiments described herein will be described referring to plan views and/or cross-sectional views by way of ideal schematic views. Accordingly, the exemplary views may be modified depending on manufacturing technologies and/or tolerances. Therefore, the disclosed embodiments are not limited to those shown in the views, but include modifications in configuration formed on the basis of manufacturing processes. Therefore, regions exemplified in figures have schematic properties, and shapes of regions shown in figures exemplify specific shapes of regions of elements, and the specific properties and shapes do not limit aspects of the invention.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

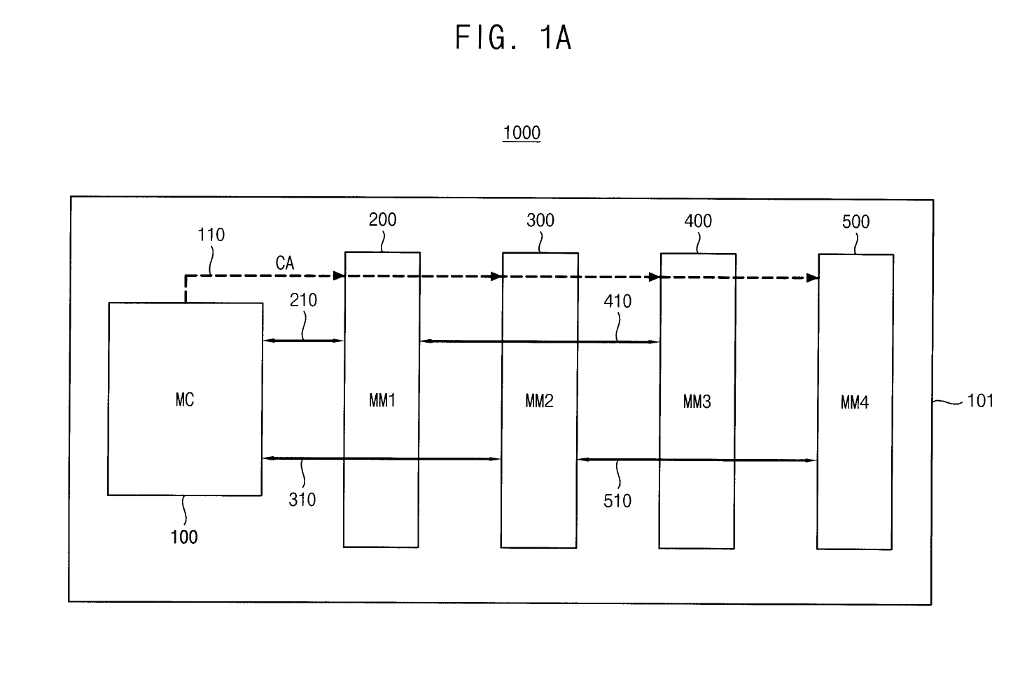

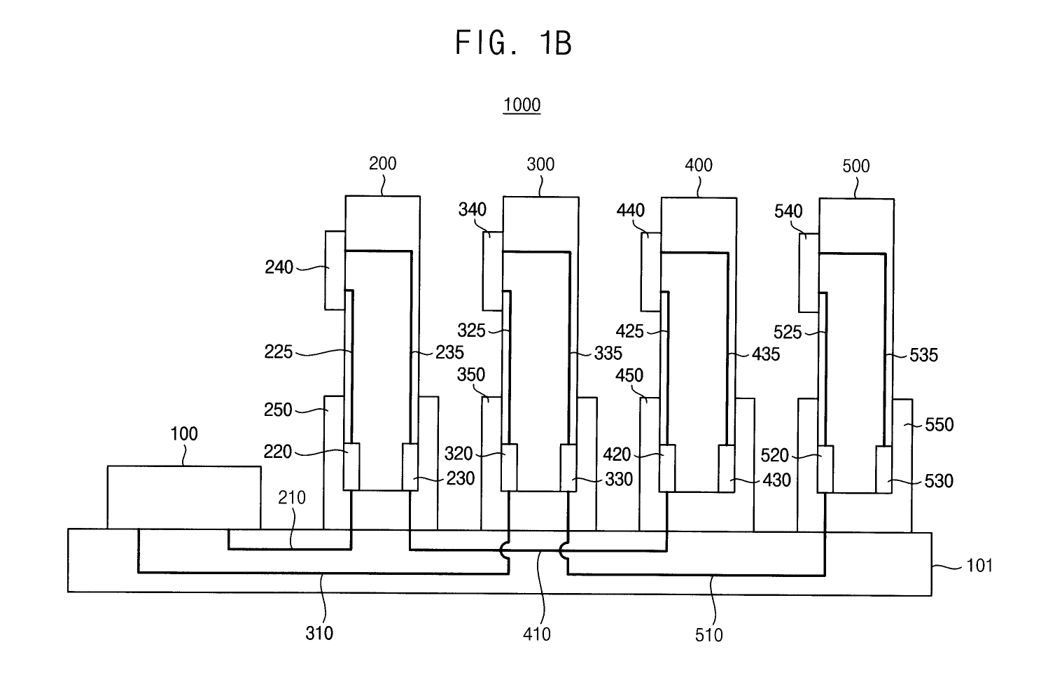

FIGS. 1A and 1B are diagrams illustrating a memory system according to example embodiments. FIG. 1A is a plan view of a memory system according to an example embodiment. FIG. 1B is a cross-sectional view of the memory system of FIG. 1A, according to an exemplary embodiment.

Referring to FIGS. 1A and 1B, a memory system 1000 includes a memory controller (MC) 100, a first memory module (MM1) 200, a second memory module (MM2) 300, a third memory module (MM3) 400 and a fourth memory module (MM4) 500 that are mounted on a base substrate 101.

The base substrate 101 may be, for example, a printed circuit board (PCB). A plurality of sockets 250, 350, 450 and 550 may be formed on the base substrate 101. Each memory module may be inserted in a respective one of the plurality of sockets 250, 350, 450 and 550. For example, the first memory module 200 may be inserted in the first socket 250.

The memory controller 100 controls the first, second, third and fourth memory modules 200, 300, 400 and 500 depending on operation modes of the memory system 1000. The memory controller 100 may provide, for example, command-address (C/A) signals CA to the memory modules 200, 300, 400 and 500, for example, through a C/A bus 110 and may exchange data with the memory modules 200, 300, 400 and 500 through first, second, third and fourth memory buses 210, 310, 410 and 510. As illustrated in FIG. 1A, the C/A bus 110 may be a uni-directional bus and each of the memory buses 210, 310, 410 and 510 may be a bi-directional bus. The C/A signals CA may include, for example, a clock signal, a clock enable signal, a write enable signal, a read enable signal, a chip selection signal, a plurality of address signals, etc.

The first memory module 200 is directly connected to the memory controller 100 through the first memory bus 210. As such, the first memory module 200 connects to the memory controller 100 without any other memory modules 200 being disposed electrically therebetween. The first memory module 200 exchanges first data with the memory controller 100 through the first memory bus 210. The second memory module 300 is directly connected to the memory controller 100 through the second memory bus 310. The second memory module 300 exchanges second data with the memory controller 100 through the second memory bus 310.

The second data is different from the first data. In one embodiment, the first data and the second data are included in a plurality of data that are simultaneously provided. For example, the first data and the second data may be simultaneously output from the memory controller 100 or may be simultaneously transmitted to the memory controller 100. For example, if each of the memory modules 200, 300, 400 and 500 is a ×64 dual in-line memory module (DIMM) that has sixty-four data input/output (I/O) pins, the first data may correspond to data signals that are output or received through thirty-two data I/O pins of the sixty-four data I/O pins. The second data may correspond to data signals that are output or received through the other thirty-two data I/O pins of the sixty-four data I/O pins in synchronization with the data signals corresponding to the first data.

The third memory module 400 is connected to the first memory module 200 through the third memory bus 410. The third memory module 400 exchanges the first data with the memory controller 100 through the first memory bus 210 and the third memory bus 410. As such, the third memory module 400 may be indirectly connected to the memory controller 100 through the first and third memory buses 210 and 410. For example, the third memory module 400 may connect to the controller 100 through another memory module disposed electrically therebetween. The fourth memory module 500 is connected to the second memory module 300 through the fourth memory bus, 510. The fourth memory module 500 exchanges the second data with the memory controller 100 through the second memory bus 310 and the fourth memory bus 510. In other words, the fourth memory module 500 may be indirectly connected to the memory controller 100 through the second and fourth memory buses 310 and 510.

In the memory system 1000 according to example embodiments, data lines in the first memory bus 210 may maintain a point-to-point connection between the memory controller 100 and the first memory module 200. Date lines in the second memory bus 310 may maintain the point-to-point connection between the memory controller 100 and the second memory module 300. Data lines in the third memory bus 410 may maintain the point-to-point connection between the first memory module 200 and the third memory module 400. Data lines in the fourth memory bus 510 may maintain the point-to-point connection between the second memory module 300 and the fourth memory module 500.

The first memory module 200 may include a plurality of first data I/O pins 220, a plurality of second data I/O pins 230, and a memory device 240. The plurality of first data I/O pins 220 may be connected to the first memory bus 210. The plurality of second data I/O pins 230 may be connected to the third memory bus 410. The memory device 240 may be connected to the plurality of first data I/O pins 220 through first internal data lines 225 and may be connected to the plurality of second data I/O pins 230 through second internal data lines 235. The second internal data lines 235 may be formed through a module substrate of the first memory module 200. For example, the second internal data lines 235 may include a through substrate via, such as a through silicon via (TSV) that is formed through the module substrate of the first memory module 200. The data lines 225 and/or 235 may include one or more wiring layers as well. I/O pins as described herein may be, for example, terminals formed of a conductive material, such as one or more metals (e.g., metal plating, etc.).

In example embodiments, the memory device 240 may be a volatile memory device, such as a dynamic random access memory (DRAM) device. Memory device 240 may include, for example, one or more semiconductor memory chips. The one or more chips may be part of a single or multi-chip package, or a package-on-package device. Although volatile memory devices are described herein, the disclosed memory devices, such as memory device 240, may be other types of devices as well. Also, although not illustrated in FIGS. 1A and 1B, the first memory module 200 may include a plurality of memory devices (e.g., eight memory devices).

Each of the second, third and fourth memory modules 300, 400 and 500 may have a structure similar to the structure of the first memory module 200. For example, the second memory module 300 may include a plurality of first data I/O pins 320 that are connected to the second memory bus 310, a plurality of second data I/O pins 330 that are connected to the fourth memory bus 510, and a volatile memory device 340 that is connected to the plurality of first data I/O pins 320 through first internal data lines 325 and is connected to the plurality of second data I/O pins 330 through second internal data lines 335. The third memory module 400 may include a plurality of first data I/O pins 420 that are connected to the third memory bus 410, a plurality of second data I/O pins 430, and a volatile memory device 440 that is connected to the plurality of first data I/O pins 420 through first internal data lines 425 and is connected to the plurality of second data I/O pins 430 through second internal data lines 435. The fourth memory module 500 may include a plurality of first data I/O pins 520 that are connected to the fourth memory bus 510, a plurality of second data I/O pins 530, and a volatile memory device 540 that is connected to the plurality of first data I/O pins 520 through first internal data lines 525 and is connected to the plurality of second data I/O pins 530 through second internal data lines 535.

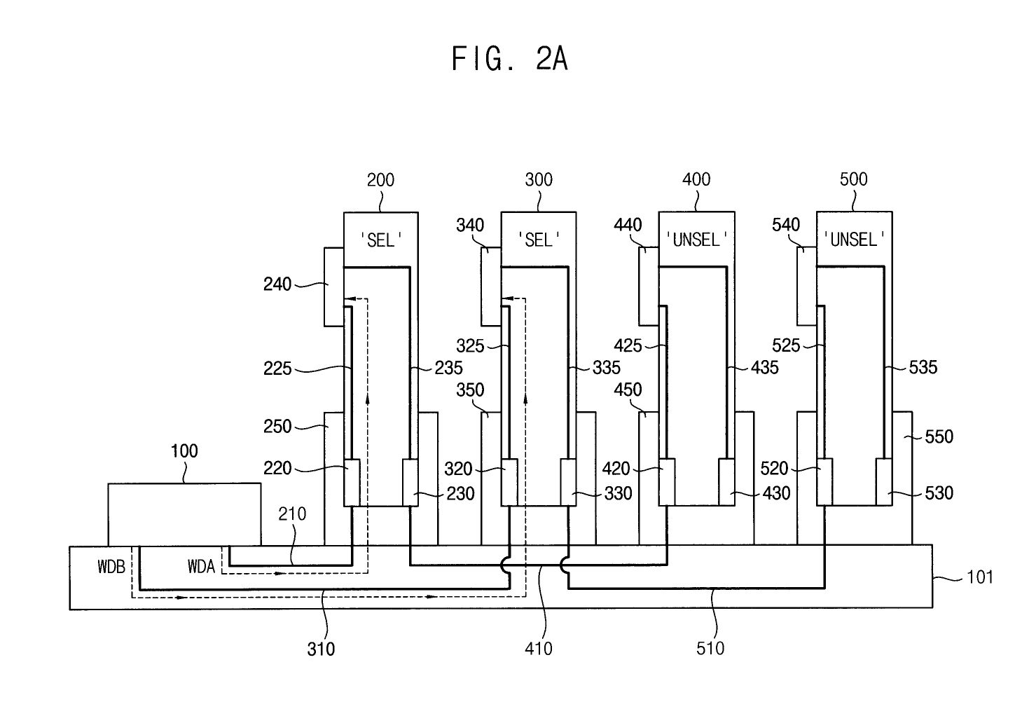

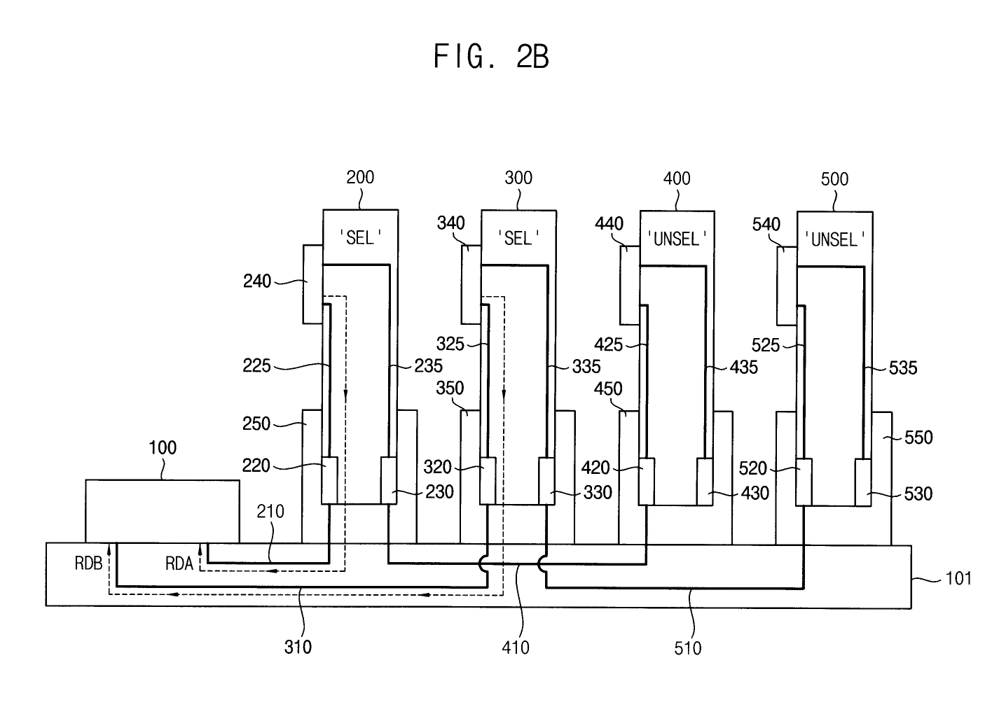

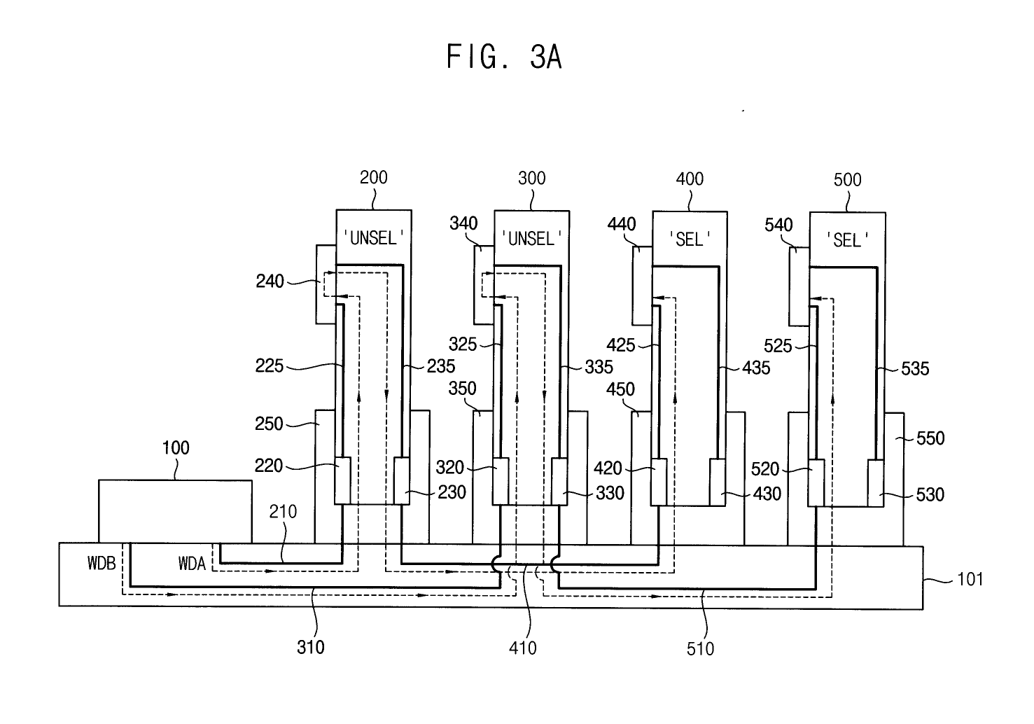

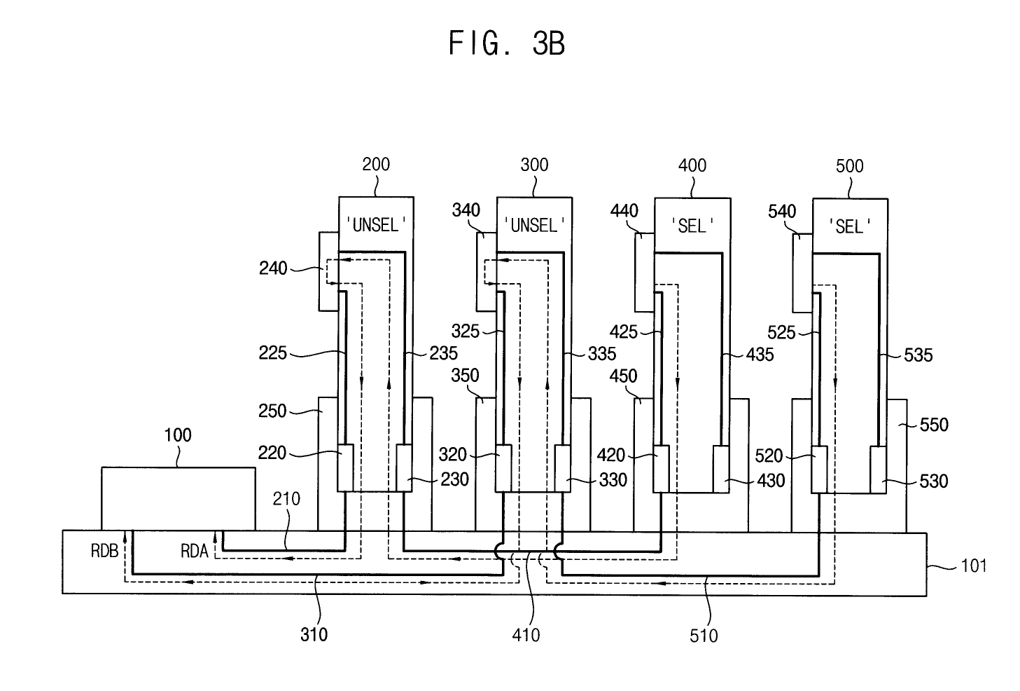

In example embodiments, the memory modules 200, 300, 400 and 500 may be divided into a first memory module group and a second memory module group. The first memory module group may include the first and third memory modules 200 and 400, and the second memory module group may include the second and fourth memory modules 300 and 500. One of the first and third memory modules 200 and 400 in the first memory module group may be selected as a first selected memory module based on a selection signal (e.g., the chip selection signal and/or a module selection signal). One of the second and fourth memory modules 300 and 500 in the second memory module group may be selected as a second selected memory module based on the selection signal. The memory controller 100 may perform a write operation or a read operation based on the first and second selected memory modules, as will be described below with reference to FIGS. 2A, 2B, 3A and 3B.

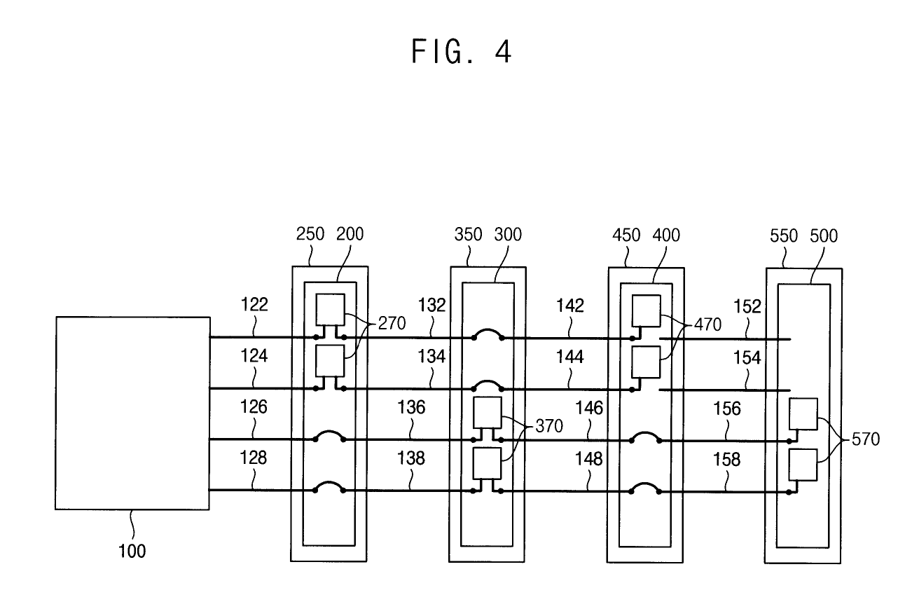

In example embodiments, the first, second, third and fourth memory buses 210, 310, 410 and 510 may be provided such that a plurality of data lines that are formed on and/or in the base substrate 101 are selectively electrically opened or shorted, as will be described below with reference to FIG. 4.

As the speed of operation of a memory system has increased, parallel signaling methods, bi-directional signaling methods and single-ended signaling methods are widely used as data transmission methods between a memory controller and a plurality of memory modules. In addition, in a conventional memory system, the memory controller is connected to the plurality of memory modules in multi-drop methods in which several memory modules are simultaneously connected to a common channel so as to increase a data storage capacity, and in stub series transmission line (SSTL) methods in which passive elements (e.g., resistors) are interposed between memory modules and a channel. In the multi-drop methods, however, as the operation frequency of the memory modules has been increased, data transmission performance has been degraded due to the signal attenuation. Thus, the conventional memory system implemented by the multi-drop methods has some limit to increase the data storage capacity.

To solve problems related to the multi-drop methods, point-to-point methods in which a plurality of memory modules are directly connected to a memory controller has been researched. However, a conventional memory system implemented by the point-to-point methods has relatively high power consumption because serial signaling methods, uni-directional signaling methods and differential signaling methods are used as data transmission methods between a memory controller and a plurality of memory modules. In addition, the number of the memory modules directly connected to the memory controller is limited in the point-to-point methods due to the arrangement of data I/O pins.

In the memory system 1000 according to certain example embodiments, the memory controller 100 is connected to the first and second memory modules 200 and 300 in point-to-point methods, and the first and second memory modules 200 and 300 are connected to the third and fourth memory modules 400 and 500 in the point-to-point methods. Thus, the memory system 1000 may have relatively high data storage capacity although low power and high speed signaling methods (e.g., the parallel signaling methods, the bi-directional signaling methods, and the single-ended signaling methods) are used as data transmission methods between the memory controller 100 and the memory modules 200, 300, 400 and 500. In addition, the plurality of data that are simultaneously provided may be divided into at least two data groups (e.g., the first and second data), the memory modules 200, 300, 400 and 500 may be divided into at least two memory module groups (e.g., the first and second memory module groups), and each data group may be stored in or read from a selected memory module of each memory module group. Thus, the plurality of data may be effectively stored in or read from the memory modules 200, 300, 400 and 500.

FIGS. 2A, 2B, 3A and 3B are diagrams for describing exemplary operations of the memory system of FIGS. 1A and 1B.

FIG. 2A illustrates a write operation based on the first and second memory modules 200 and 300. FIG. 2B illustrates a read operation based on the first and second memory modules 200 and 300. FIG. 3A illustrates a write operation based on the third and fourth memory modules 400 and 500. FIG. 3B illustrates a read operation based on the third and fourth memory modules 400 and 500. In FIGS. 2A, 2B, 3A and 3B, ‘SEL’ indicates a selected memory module and ‘UNSEL’ indicates an unselected memory module.

Referring to FIG. 2A, the memory controller 100 may select the first memory module 200 and the second memory module 300 based on the selection signal (e.g., a chip select signal). In this case, the first memory module 200 may correspond to the first selected memory module, and the second memory module 300 may correspond to the second selected memory module. During a write mode, the memory controller 100 may store first write data WDA of write data in the first memory module 200 (e.g., the first selected memory module) and may store second write data WDB of the write data in the second memory module 300 (e.g., the second selected memory module). The second write data WDB may be different from the first write data WDA, and the first and second write data WDA and WDB may be simultaneously output from the memory controller 100. The write data, the first write data WDA and the second write data WDB in FIG. 2A may correspond to the plurality of data, the first data and the second data that are described above with reference to FIG. 1, respectively.

Referring to FIG. 2B, the memory controller 100 may select the first memory module 200 and the second memory module 300 based on the selection signal. During a read mode, the memory controller 100 may read first read data RDA of read data from the first memory module 200 (e.g., the first selected memory module) and may read second read data RDB of the read data from the second memory module 300 (e.g., the second selected memory module). The second read data RDB may be different from the first read data RDA, and the first and second read data RDA and RDB may be simultaneously transmitted to the memory controller 100. The read data, the first read data RDA and the second read data RDB in FIG. 2B may correspond to the plurality of data, the first data and the second data that are described above with reference to FIG. 1, respectively.

The volatile memory device 240 included in the first memory module 200 may exchange the first data (e.g., the first write data WDA and the first read data RDA) with the memory controller 100 through the first memory bus 210, the plurality of first data I/O pins 220 and the first internal data lines 225. The volatile memory device 340 included in the second memory module 300 may exchange the second data (e.g., the second write data WDB and the second read data RDB) with the memory controller 100 through the second memory bus 310, the plurality of first data I/O pins 320 and the first internal data lines 325.

In example embodiments, a first unselected memory module and a second unselected memory module may be disabled based on the selection signal. The first unselected memory module may be the other one of the first and third memory modules 200 and 400 that is not selected, and the second unselected memory module may indicate the other one of the second and fourth memory modules 300 and 500 that is not selected. For example, the memory controller 100 may disable the third memory module 400 (e.g., the first unselected memory module) of the first memory module group and the fourth memory module 500 (e.g., the second unselected memory module) of the second memory module group. Here, “disabled” or “disable” represents, for example, that the power supplied to a memory module is blocked out or a memory module operates in a standby mode, a sleep mode, or a deep power-down mode. Further, unused data I/O pins, e.g., the plurality of second data I/O pins 230 in the first memory module 200 and the plurality of second data I/O pins 330 in the second memory module 300, may be disabled based on the selection signal.

Referring to FIG. 3A, the memory controller 100 may select the third memory module 400 and the fourth memory module 500 based on the selection signal. During the write mode, the memory controller 100 may store the first write data WDA of the write data in the third memory module 400 (e.g., the first selected memory module) and may store the second write data WDB of the write data in the fourth memory module 500 (e.g., the second selected memory module).

Referring to FIG. 3B, the memory controller 100 may select the third memory module 400 and the fourth memory module 500 based on the selection signal. During the read mode, the memory controller 100 may read the first read data RDA of the read data from the third memory module 400 (e.g., the first selected memory module) and may read the second read data RDB of the read data from the fourth memory module 400 (e.g., the second selected memory module).

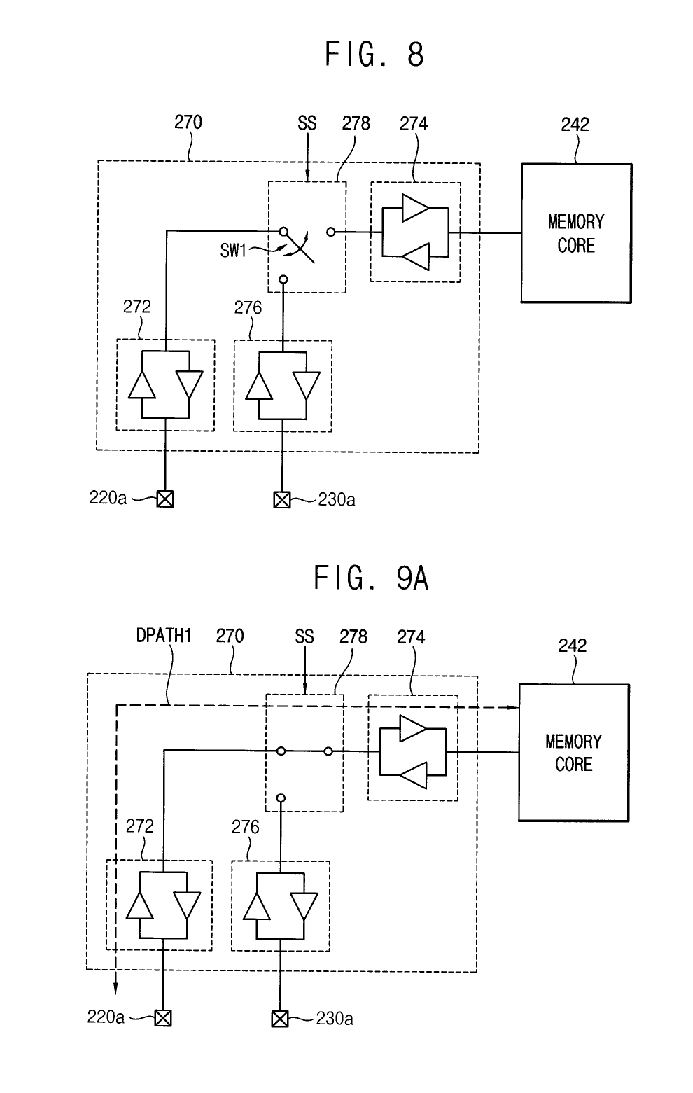

The volatile memory device 440 included in the third memory module 400 may exchange the first data (e.g., the first write data WDA and the first read data RDA) with the memory controller 100 through the first memory bus 210, the first memory module 200, the third memory bus 410, the plurality of first data I/O pins 420 and the first internal data lines 425. The first data may be transmitted from one of the memory controller 100 and the third memory module 400 to another one of the memory controller 100 and the third memory module 400 through the first memory bus 210, the plurality of first data I/O pins 220, the first internal data lines 225, the volatile memory device 240 in the first memory module 200, the second internal data lines 235, the plurality of second data I/O pins 230 and the third memory bus 410. For example, the first write data WDA may be transmitted from the memory controller 100 to the third memory module 400 through the first memory bus 210, the plurality of first data I/O pins 220, the first internal data lines 225, the volatile memory device 240 in the first memory module 200, the second internal data lines 235, the plurality of second data I/O pins 230 and the third memory bus 410. The first read data RDA may be transmitted from the third memory module 400 to the memory controller 100 through the third memory bus 410, the plurality of second data I/O pins 230, the second internal data lines 235, the volatile memory device 240 in the first memory module 200, the first internal data lines 225, the plurality of first data I/O pins 220 and the first memory bus 210. In this case, the volatile memory device 240 in the first memory module 200 may provide a data path between the plurality of first data I/O pins 220 and the plurality of second data I/O pins 230, as will be described below with reference to FIGS. 8, 9A, 9B and 10.

Similarly, the volatile memory device 540 included in the fourth memory module 500 may exchange the second data (e.g., the second write data WDB and the second read data RDB) with the memory controller 100 through the second memory bus 310, the second memory module 300, the fourth memory bus 510, the plurality of first data I/O pins 520 and the first internal data lines 525. The second data may be transmitted from one of the memory controller 100 and the fourth memory module 500 to another one of the memory controller 100 and the fourth memory module 500 through the second memory bus 310, the plurality of first data I/O pins 320, the first internal data lines 325, the volatile memory device 340 in the second memory module 300, the second internal data lines 335, the plurality of second data I/O pins 330 and the fourth memory bus 510. In this case, the volatile memory device 340 in the second memory module 300 may provide a data path between the plurality of first data I/O pins 320 and the plurality of second data I/O pins 330.

In example embodiments, the first unselected memory module and the second unselected memory module may be disabled based on the selection signal. For example, the memory controller 100 may partially disable the first memory module 200 (e.g., the first unselected memory module) of the first memory module group and the second memory module 300 (e.g., the second unselected memory module) of the second memory module group. In other words, the first memory module 200 may be disabled except for the data path in the first memory module 200 between the plurality of first data I/O pins 220 and the plurality of second data I/O pins 230, and the second memory module 300 may be disabled except for the data path in the second memory module 300 between the plurality of first data I/O pins 320 and the plurality of second data I/O pins 330. Further, unused data I/O pins, e.g., the plurality of second data I/O pins 430 in the third memory module 400 and the plurality of second data I/O pins 530 in the fourth memory module 500, may be disabled based on the selection signal.

In example embodiments, a distance between the memory controller and the selected memory module may be varied. For example, distances between the memory controller 100 and the selected memory modules 200 and 300 in the example of FIGS. 2A and 2B may be different from distances between the memory controller 100 and the selected memory modules 400 and 500 in the example of FIGS. 3A and 3B. Data transmission latency may be varied depending on a position of each selected memory module. Thus, the memory system 1000 according to example embodiments may perform a training operation to compensate a difference of the data transmission latency.

Although not illustrated in FIGS. 2A, 2B, 3A and 3B, the first and fourth memory modules 200 and 500 may be selected as the first and second selected memory modules, respectively. The second and third memory modules 300 and 400 may be selected as the first and second selected memory modules, respectively.

FIG. 4 is a diagram for describing a structure of the memory system of FIGS. 1A and 1B.

Referring to FIGS. 1A, 1B and 4, a plurality of data line sets 122, 124, 126, 128, 132, 134, 136, 138, 142, 144, 146, 148, 152, 154, 156 and 158 may be formed on and/or in the base substrate 101. For example, first, second, third and fourth data line sets 122, 124, 126 and 128 may be formed on and/or in the base substrate 101 between the memory controller and the first socket 250. Fifth, sixth, seventh and eighth data line sets 132, 134, 136 and 138 may be formed on and/or in the base substrate 101 between the first socket 250 and the second socket 350. Ninth, tenth, eleventh and twelfth data line sets 142, 144, 146 and 148 may be formed on and/or in the base substrate 101 between the second socket 350 and the third socket 450. Thirteenth, fourteenth, fifteenth and sixteenth data line sets 152, 154, 156 and 158 may be formed on and/or in the base substrate 101 between the third socket 450 and the fourth socket 550. Each data line set may include a plurality of data lines.

The first, second, third and fourth memory buses 210, 310, 410 and 510 may be provided by selectively open-circuiting or short-circuiting the plurality of data line sets 122, 124, 126, 128, 132, 134, 136, 138, 142, 144, 146, 148, 152, 154, 156 and 158. In detail, the first memory bus 210 may be provided by electrically connecting (e.g., short-circuiting) each of the first and second data line sets 122 and 124 to a respective one of data I/O buffer units 270. The data I/O buffer units 270 may be included in the first memory module 200 that is inserted in the first socket 250. The second memory bus 310 may be provided by electrically connecting the third data line set 126 to the seventh data line set 136, by electrically connecting the fourth data line set 128 to the eighth data line set 138, and by electrically connecting each of the seventh and eighth data line sets 136 and 138 to a respective one of data I/O buffer units 370. The data I/O buffer units 370 may be included in the second memory module 300 that is inserted in the second socket 350. The third memory bus 410 may be provided by electrically connecting each of the fifth and sixth data line sets 132 and 134 to the respective one of data I/O buffer units 270, by electrically connecting the fifth data line set 132 to the ninth data line set 142, by electrically connecting the sixth data line set 134 to the tenth data line set 144, and by electrically connecting each of the ninth and tenth data line sets 142 and 144 to a respective one of data I/O buffer units 470. The data I/O buffer units 470 may be included in the third memory module 400 that is inserted in the third socket 450. The fourth memory bus 510 may be provided by electrically connecting each of the eleventh and twelfth data line sets 146 and 148 to the respective one of data I/O buffer units 370, by electrically connecting the eleventh data line set 146 to the fifteenth data line set 156, by electrically connecting the twelfth data line set 148 to the sixteenth data line set 158, and by electrically connecting each of the fifteenth and sixteenth data line sets 156 and 158 to a respective one of data I/O buffer units 570. The data I/O buffer units 570 may be included in the fourth memory module 500 that is inserted in the fourth socket 550. The thirteenth and fourteenth data line sets 152 and 154 may be electrically opened (e.g., open-circuiting), respectively.

In example embodiments, if each memory module is the ×64 DIMM, each data line set (e.g., 122, 124, etc.) may include sixteen data lines. In this case, the memory system 1000 may have a structure of “×32 per DIMM” where each memory module exchanges 32-bit data with the memory controller 100. The memory system 1000 may have a structure of “4DIMM per channel (4DPC)” where four memory modules are included in a single channel.

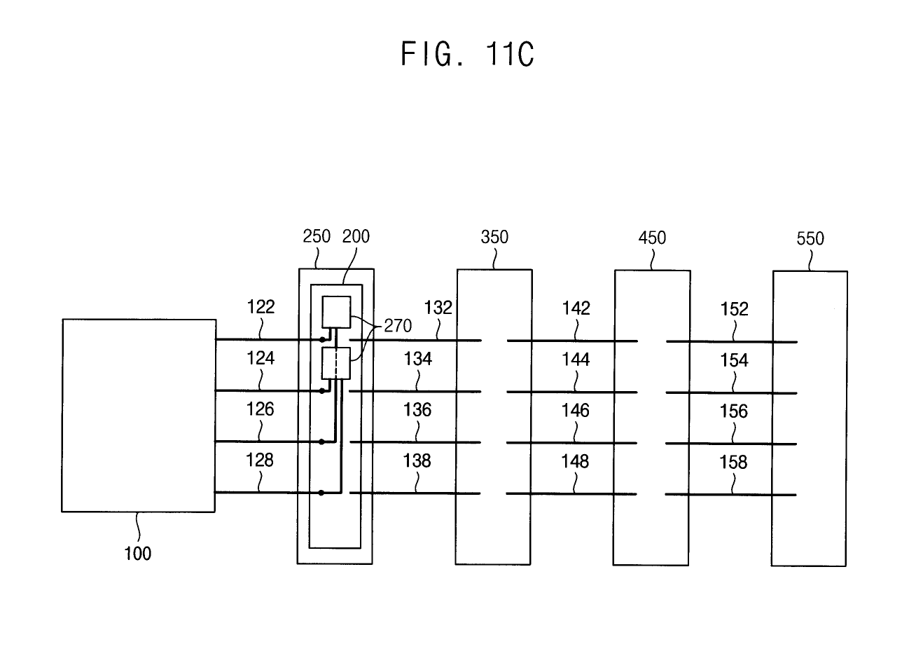

In example embodiments, the structure of the memory system 1000 may be changed depending on connections of the data line sets and/or whether the memory module is inserted in the corresponding socket, as will be described below with reference to FIGS. 11A, 11B and 11C.

Although FIG. 4 illustrates that a single data line set (e.g., the data line set 122) is connected to a single data I/O buffer unit (e.g., the data I/O buffer unit 270), each of the plurality of data lines in the single data line set may be connected to the single data I/O buffer unit. Although not illustrated in FIG. 4, data I/O buffer units may be disposed on positions that correspond to connections of the data line sets (e.g., a position where the data line sets 126 and 136 are electrically connected). For convenience of illustration, the data I/O buffer units that are not electrically connected to the data line sets may be omitted.

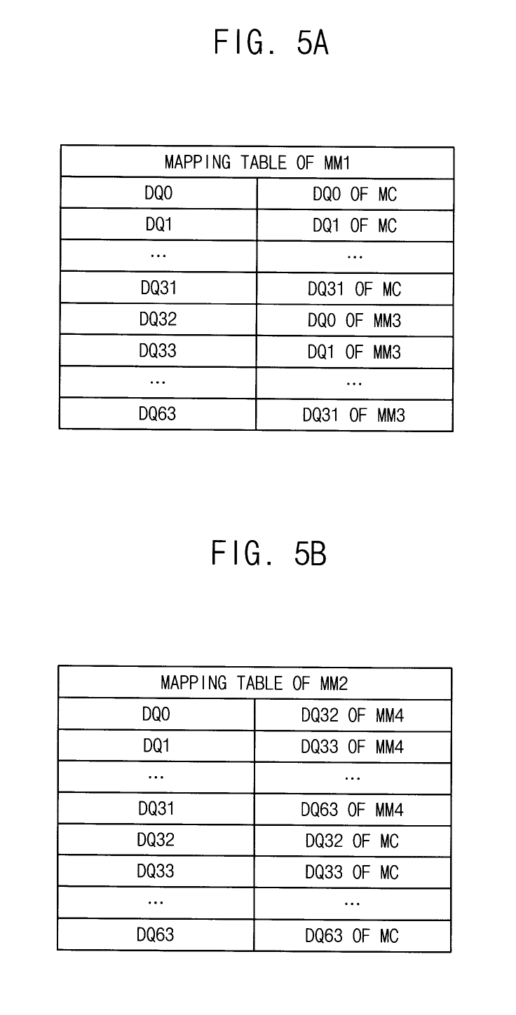

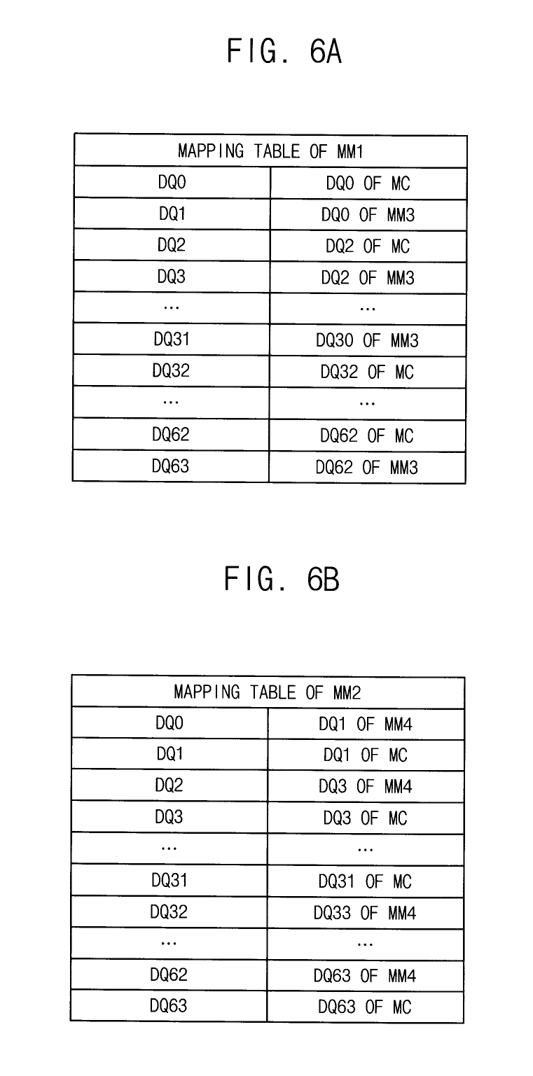

FIGS. 5A, 5B, 6A and 6B are tables for describing exemplary connections of the data I/O pins in the memory system of FIGS. 1A and 1B. In FIGS. 5A, 5B, 6A and 6B, it is assumed that each memory module is ×64 DIMM.

Referring to FIGS. 5A and 5B, the first memory module group including the first and third memory modules 200 and 400 may exchange lower 32-bit data of 64-bit data with the memory controller 100. The second memory module group including the second and fourth memory modules 300 and 500 may exchange upper 32-bit data of the 64-bit data with the memory controller 100.

In detail, in certain embodiments, each of lower bit I/O pins DQ0, DQ1, . . . , DQ31 of the first memory module 200 may be connected to a respective one of lower bit I/O pins DQ0, DQ1, . . . , DQ31 of the memory controller 100 such that the first memory module 200 exchanges the lower 32-bit data with the memory controller 100. Each of upper bit I/O pins DQ32, DQ33, . . . , DQ63 of the first memory module 200 may be connected to a respective one of lower bit I/O pins DQ0, DQ1, . . . , DQ31 of the third memory module 400 such that the third memory module 400 exchanges the lower 32-bit data with the memory controller 100 through the first memory module 200. Each of upper bit I/O pins DQ32, DQ33, . . . , DQ63 of the second memory module 300 may be connected to a respective one of upper bit I/O pins DQ32, DQ33, . . . , DQ63 of the memory controller 100 such that the second memory module 300 exchanges the upper 32-bit data with the memory controller 100. Each of lower bit I/O pins DQ0, DQ1, . . . , DQ31 of the second memory module 300 may be connected to a respective one of upper bit I/O pins DQ32, DQ33, . . . , DQ63 of the fourth memory module 500 such that the fourth memory module 500 exchanges the upper 32-bit data with the memory controller 100 through the second memory module 300.

Referring to FIGS. 6A and 6B, the first memory module group including the first and third memory modules 200 and 400 may exchange lower even-numbered bit data of 64-bit data with the memory controller 100. The second memory module group including the second and fourth memory modules 300 and 500 may exchange odd-numbered bit data of the 64-bit data with the memory controller 100.

In detail, each of even-numbered bit I/O pins DQ0, DQ2, . . . , DQ32, . . . , DQ62 of the first memory module 200 may be connected to a respective one of even-numbered bit I/O pins DQ0, DQ2, . . . , DQ32, . . . , DQ62 of the memory controller 100 such that the first memory module 200 exchanges the even-numbered bit data with the memory controller 100. Each of odd-numbered bit I/O pins DQ1, DQ3, . . . , DQ31, . . . , DQ63 of the first memory module 200 may be connected to a respective one of even-numbered bit I/O pins DQ0, DQ2, . . . , DQ30, . . . , DQ62 of the third memory module 400 such that the third memory module 400 exchanges the even-numbered bit data with the memory controller 100 through the first memory module 200. Each of odd-numbered bit I/O pins DQ1, DQ3, . . . , DQ31, . . . , DQ63 of the second memory module 300 may be connected to a respective one of odd-numbered bit I/O pins DQ1, DQ3, . . . , DQ31, . . . , DQ63 of the memory controller 100 such that the second memory module 300 exchanges the odd-numbered bit data with the memory controller 100. Each of even-numbered I/O pins DQ0, DQ2, . . . , DQ32, . . . , DQ62 of the second memory module 300 may be connected to a respective one of odd-numbered bit I/O pins DQ1, DQ3, . . . , DQ33, . . . , DQ63 of the fourth memory module 500 such that the fourth memory module 500 exchanges the odd-numbered bit data with the memory controller 100 through the second memory module 300.

Although two example embodiments with respect to the connections of the data I/O pins in the memory system 1000 of FIGS. 1A and 1B are described above with reference to FIGS. 5A, 5B, 6A and 6B, the connections of the data I/O pins in the memory system according to example embodiments are not limited thereto. In other embodiments, pins in each memory module can be grouped into first and second sets in different ways, such that, for example, in an intermediary memory module, a first set of pins connects to the controller, and a second set of pins connects to another memory module.

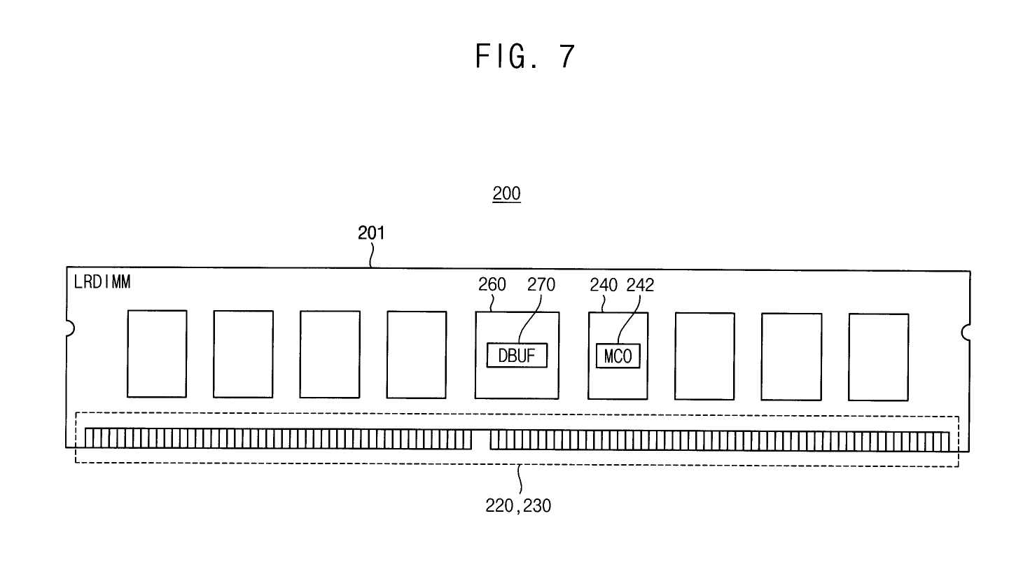

FIG. 7 is a diagram illustrating an example of a first memory module included in the memory system of FIGS. 1A and 1B, according to one embodiment.

Referring to FIGS. 1A, 1B and 7, the first memory module 200 may be a load reduced DIMM (LRDIMM). The first memory module 200 may include a plurality of first and second data I/O pins 220 and 230, a plurality of volatile memory devices 240 and a buffer 260 that are formed on a memory module substrate 201.

The plurality of first data I/O pins 220 may be formed on a first surface of the memory module substrate 201, and the plurality of second data I/O pins 230 may be formed on a second surface of the memory module substrate 201. The second surface of the memory module substrate 201 may be opposite to the first surface of the memory module substrate 201. Each volatile memory device 240 may include a memory core (MCO) 242 that includes, for example, a memory cell array, a row decoder, a column decoder, a sense amplifier, etc.

The buffer 260 may receive the C/A signal CA and the plurality of data from the memory controller 100, and may provide the C/A signal CA and the plurality of data to each volatile memory device 240. Data transmission lines may be connected between the buffer 260 and the plurality of volatile memory devices, for example, in the point-to-point method. C/A transmission lines may be connected between the buffer 260 and the plurality of volatile memory devices, for example, in the multi-drop method, a daisy-chain method or a fly-by daisy-chain method.

The buffer 260 may include a data I/O buffer unit (DBUF) 270. Although FIG. 7 illustrates that the buffer 260 includes one data I/O buffer unit, the buffer 260 may include a plurality of data I/O buffer units such that the number of the data I/O buffer units corresponds, for example, to the number of the data I/O pins 220 and 230.

In example embodiments, the first memory module 200 may be an unbuffered DIMM (UDIMM), a registered DIMM (RDIMM) or a fully buffered DIMM (FBDIMM). If the first memory module does not include the buffer 260 or an element corresponding to the buffer 260 (e.g., if the first memory module is the UDIMM), the data I/O buffer unit 270 may be included in each volatile memory device 240.

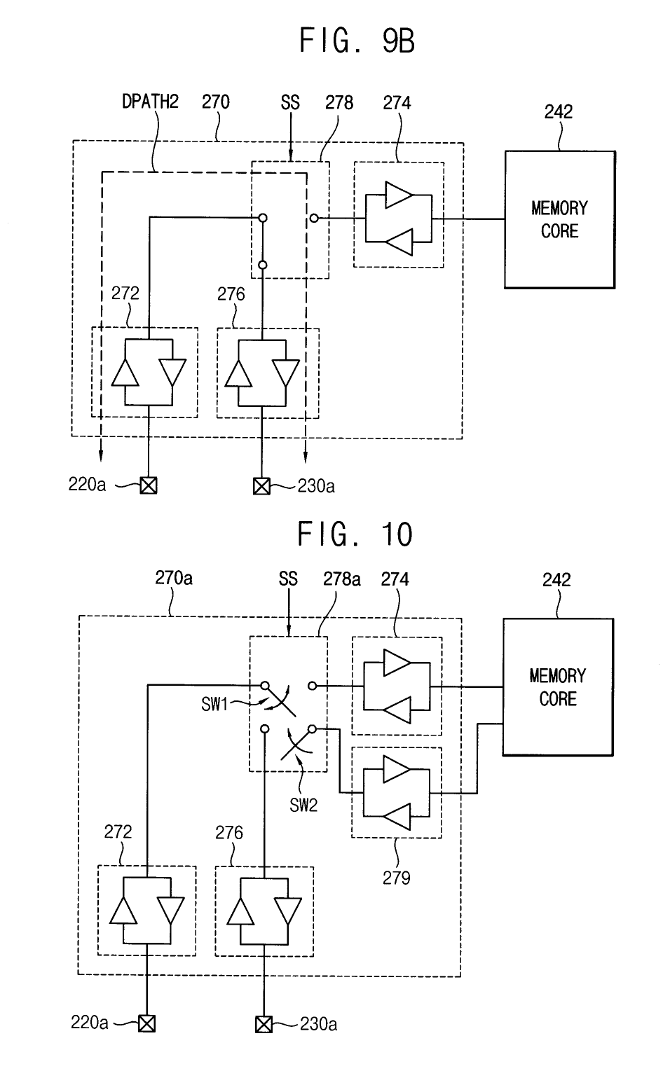

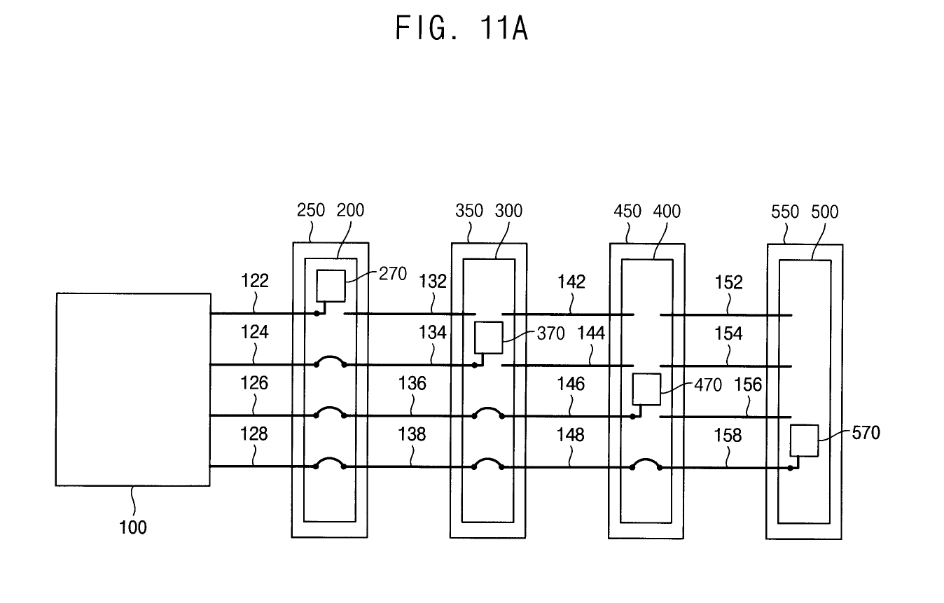

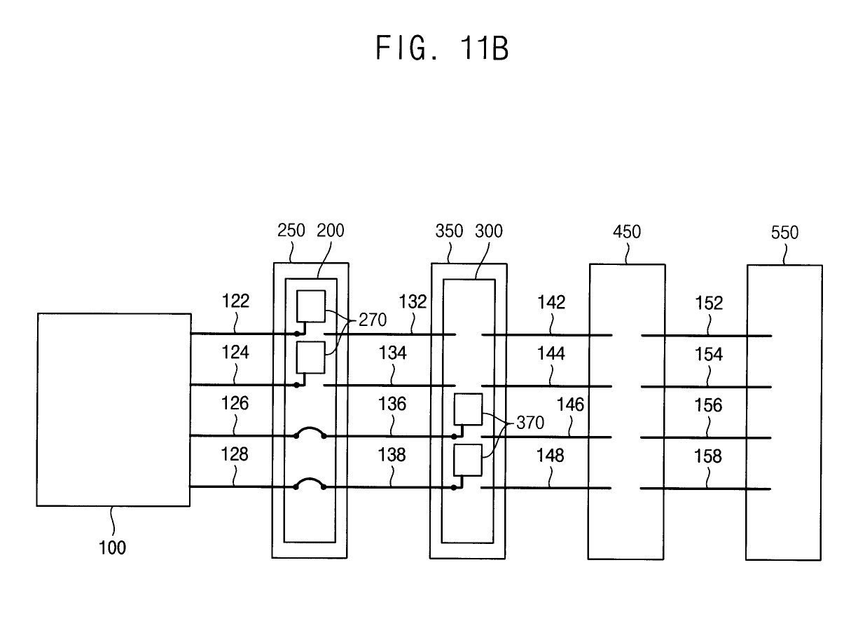

FIG. 8 is a block diagram illustrating an example of a data I/O buffer unit included in the first memory module of FIG. 7, according to one embodiment. FIGS. 9A and 9B are diagrams for describing exemplary operations of the data I/O buffer unit of FIG. 8.

Referring to FIGS. 8, 9A and 9B, the data I/O buffer unit 270 may be a circuit that includes a first buffer unit 272, a second buffer unit 274, a third buffer unit 276 and a path selection unit 278.

The first buffer unit 272 may be a circuit connected to one (e.g. a pin 220a) of the plurality of first data I/O pins 220. The second buffer unit 274 may be a circuit connected to the memory core 242. The third buffer unit 276 may be a circuit connected to one (e.g., a pin 230a) of the plurality of second data I/O pins 230. Each of the first, second and third buffer unit 272, 274 and 276 may include circuitry including one output driver and one input buffer.

The path selection unit 278 may connect one of the second buffer unit 274 and the third buffer unit 276 to the first buffer unit 272 based on a selection signal SS. For example, the selection signal SS may be substantially the same as the signal (e.g., the chip selection signal) that is provided from the memory controller 100 in FIG. 1 and is used for selecting the first and second selected memory modules. The path selection unit 278 may be a circuit including a first switch SW1. As such, in one embodiment, the first buffer unit 272 is fixedly electrically connected to one of the plurality of first data I/O pins 220, the second buffer unit 274 is fixedly electrically connected to the memory core 242, and the third buffer unit 276 is fixedly electrically connected to one of the plurality of second data I/O pins 230. The first buffer unit 272 is selectively electrically connected to each of the second buffer unit 274 and the third buffer unit 276, for example, through the path selection unit 278. As a result, a memory core in the first memory module 200 is selectively electrically connected to the first bus 210 and the first bus 210 is selectively electrically connected to the third bus 410. Other memory cores and buses can be connected in a similar manner.

The data I/O buffer unit 270 may include a first path DPATH1 and a second path DPATH2. The first path DPATH1 may indicate a path between the pin 220a of the first data I/O pins 220 and the memory core 242. The second path DPATH2 may indicate a path between the pin 220a of the first data I/O pins 220 and the pin 230a of the second data I/O pins 230. One of the first path DPATH1 and the second path DPATH2 may be selectively enabled based on the selection signal SS.

For example, when the first memory module 200 is selected as the first selected memory module, the path selection unit 278 electrically connects the second buffer unit 274 to the first buffer unit 272, and thus the first path DPATH1 is enabled, as illustrated in FIG. 9A. During the write mode, one bit of the first write data WDA that is received from the memory controller 100 through the first memory bus 210 is transmitted to the memory core 242 through the first path DPATH1. During the read mode, one bit of the first read data RDA that is stored in the memory core 242 may be transmitted to the memory controller 100 through the first path DPATH1. In this case, the third buffer unit 276 that is not connected to the first buffer unit 272 is disabled based on the selection signal SS.

For another example, when the third memory module 400 is selected as the first selected memory module, the path selection unit 278 electrically connects the third buffer unit 276 to the first buffer unit 272, and thus the second path DPATH2 is enabled, as illustrated in FIG. 9B. During the write mode, one bit of the first write data WDA that is received from the memory controller 100 through the first memory bus 210 may be transmitted to the third memory module 400 through the second path DPATH2 and the third memory bus 410. During the read mode, one bit of the first read data RDA that is stored in the third memory module 400 may be transmitted to the memory controller 100 through third memory bus 410, the second path DPATH2 and the first memory bus 210. In this case, the second buffer unit 274 that is not connected to the first buffer unit 272 is disabled based on the selection signal SS.

FIG. 10 is a block diagram illustrating another example of the data I/O buffer unit included in the first memory module of FIG. 7, according to another embodiment.

Referring to FIG. 10, a data I/O buffer unit 270a may include a first buffer unit 272, a second buffer unit 274, a third buffer unit 276, a fourth buffer unit 279 and a path selection unit 278a.

In comparison with the data I/O buffer unit 270 of FIG. 8, the data I/O buffer unit 270a may further include the fourth buffer unit 279, and thus the path selection unit 278a may be different from the path selection unit 278 in FIG. 8. The fourth buffer unit 279 may be connected to the memory core 242 and may include one output driver and one input buffer.

The path selection unit 278a may connect one of the second buffer unit 274 and the third buffer unit 276 to the first buffer unit 272 based on a selection signal SS. In addition, the path selection unit 278a may further connected the third buffer unit 276 to the fourth buffer unit 279 based on the selection signal SS when the second buffer unit 274 is connected to the first buffer unit 272. In this case, data received from the memory controller 100 through the pins 220a and 230a may be transmitted to the memory core 242, or data stored in the memory core 242 may be transmitted to the memory controller 100 through the pins 220a and 230a. The path selection unit 278a may include a first switch SW1 and a second switch SW2. As such, in one embodiment, the first buffer unit 272 is fixedly electrically connected to one of the plurality of first data I/O pins 220a, the second buffer unit 274 is fixedly electrically connected to the memory core 242, the third buffer unit 276 is fixedly electrically connected to one of the plurality of second data I/O pins 230a, and the fourth buffer unit 279 is fixedly electrically connected to the memory core 242. The first buffer unit 272 is selectively electrically connected to each of the second buffer unit 274 and the third buffer unit 276, for example, through the path selection unit 278a (e.g., via switch SW1). The fourth buffer unit 279 is selectively electrically connected to the third buffer unit 276, for example, through the patch selection unit 278a (e.g., via switch SW2).

Although not illustrated in FIGS. 7, 8, 9A, 9B and 10, the second memory module 300 may have a structure that is substantially the same as the structure of the first memory module 200 and may include a plurality of data I/O buffer units each of which is one of the data I/O buffer unit 270 of FIG. 8 and the data I/O buffer unit 270a of FIG. 10. Each of the third and fourth memory modules 400 and 500 may have a structure that is substantially the same as the structure of the first memory module 200 and may include a plurality of data I/O buffer units each of which is one of the data I/O buffer unit 270 of FIG. 8 and the data I/O buffer unit 270a of FIG. 10, however, the second path of each data I/O buffer unit in the third and fourth memory modules 400 and 500 may be not enabled.

FIGS. 11A, 11B and 11C are diagrams for describing modified structures of the memory system of FIGS. 1A and 1B, according to another exemplary embodiment.

Referring to FIG. 11A, first, second, third and fourth memory modules 200, 300, 400 and 500 may exchange first, second, third and fourth data of the plurality of data with the memory controller 100, respectively. For example, the first memory module 200 may exchange the first data with the memory controller 100, the second memory module 300 may exchange the second data with the memory controller 100, the third memory module 400 may exchange the third data with the memory controller 100, and the fourth memory module 500 may exchange the fourth data with the memory controller 100. If each memory module is the ×64 DIMM, the memory system of FIG. 11A may have the structure of “4DPC,” which is substantially the same as the memory system of FIG. 4, however, the memory system of FIG. 11A may have a structure of “×16 per DIMM” where each memory module exchanges 16-bit data with the memory controller 100, which is different from the memory system of FIG. 4.

In FIG. 11A, a first memory bus between the first memory module 200 and the memory controller 100 may be provided by electrically connecting (e.g., short-circuiting) a first data line set 122 to a data I/O buffer unit 270 that is included in the first memory module 200. A second memory bus between the second memory module 300 and the memory controller 100 may be provided by electrically connecting a second data line set 124 to a sixth data line set 134, and by electrically connecting the sixth data line set 134 to a data I/O buffer unit 370 that is included in the second memory module 300. A third memory bus between the third memory module 400 and the memory controller 100 may be provided by electrically connecting a third data line set 126 to a seventh data line set 136, by electrically connecting the seventh data line set 136 to an eleventh data line set 146, and by electrically connecting the eleventh data line set 146 to a data I/O buffer unit 470 that is included in the third memory module 400. A fourth memory bus between the fourth memory module 500 and the memory controller 100 may be provided by electrically connecting a fourth data line set 128 to an eighth data line set 138, by electrically connecting the eighth data line set 138 to a twelfth data line set 148, by electrically connecting the twelfth data line set 148 to a sixteenth data line set 158, and by electrically connecting the sixteenth data line set 158 to a data I/O buffer unit 570 that is included in the fourth memory module 500. Fifth, ninth, tenth, thirteenth, fourteenth and fifteenth data line sets 132, 142, 144, 152, 154 and 156 may be electrically opened (e.g., open-circuiting), respectively.

Referring to FIG. 11B, first and second memory modules 200 and 300 may exchange first and second data of the plurality of data with the memory controller 100, respectively. For example, the first memory module 200 may exchange the first data with the memory controller 100, and the second memory module 300 may exchange the second data with the memory controller 100. A memory module may be not inserted in each of third and fourth sockets 450 and 550. If each memory module is the ×64 DIMM, the memory system of FIG. 11B may have the structure of “×32 per DIMM,” which is substantially the same as the memory system of FIG. 4, however, the memory system of FIG. 11B may have a structure of “2DPC” where two memory modules are included in a single channel, which is different from the memory system of FIG. 4.

In FIG. 11B, a first memory bus between the first memory module 200 and the memory controller 100 may be provided by electrically connecting (e.g., short-circuiting) each of first and second data line sets 122 and 124 to a respective one of data I/O buffer units 270 that is included in the first memory module 200. A second memory bus between the second memory module 300 and the memory controller 100 may be provided by electrically connecting a third data line set 126 to a seventh data line set 136, by electrically connecting a fourth data line set 128 to an eighth data line set 138, and by electrically connecting each of the seventh and eighth data line sets 136 and 138 to a respective one of data I/O buffer units 370 that is included in the second memory module 300. Fifth, sixth, ninth, tenth, eleventh, twelfth, thirteenth, fourteenth, fifteenth and sixteenth data line sets 132, 134, 142, 144, 146, 148, 152, 154, 156 and 158 may be electrically opened (e.g., open-circuiting), respectively.

Referring to FIG. 11C, a first memory module 200 may exchange the plurality of data with the memory controller 100. A memory module may be not inserted in each of second, third and fourth sockets 350, 450 and 550. If each memory module is the ×64 DIMM, the memory system of FIG. 11C may have the structure of “×64 per DIMM” where each memory module exchanges 64-bit data with the memory controller 100, and a structure of “1DPC” where one memory module is included in a single channel, which are different from the memory system of FIG. 4.

In FIG. 11C, a memory bus between the first memory module 200 and the memory controller 100 may be provided by electrically connecting (e.g., short-circuiting) first and third data line sets 122 and 126 to one of data I/O buffer units 270 that is included in the first memory module 200, and by electrically connecting second and fourth data line sets 124 and 128 to another one of the data I/O buffer units 270. In this case, each data I/O buffer unit may be the data I/O buffer unit 270a of FIG. 10. Data received from the memory controller 100 through the pins 220 and 230 may be transmitted to the memory core 242, or data stored in the memory core 242 may be transmitted to the memory controller 100 through the pins 220 and 230. Fifth through sixteenth data line sets 132, 134, 136, 138, 142, 144, 146, 148, 152, 154, 156 and 158 may be electrically opened (e.g., open-circuiting), respectively.

In example embodiments, the memory system 1000 may have one of various structures depending on the user setting. For example, the structure of the memory system 1000 may be determined as one of structures illustrated in FIGS. 4, 11A, 11B and 11C based on a mode register setting (MRS) command or a basic input output system (BIOS) command. The MRS command and/or BIOS command may instruct, for example, which data line sets have open circuits and which have short circuits. For another example, the structure of the memory system 1000 may be changed from one of structures illustrated in FIGS. 4, 11A, 11B and 11C to another one of structures illustrated in FIGS. 4, 11A, 11B and 11C based on the MRS command or the BIOS command.

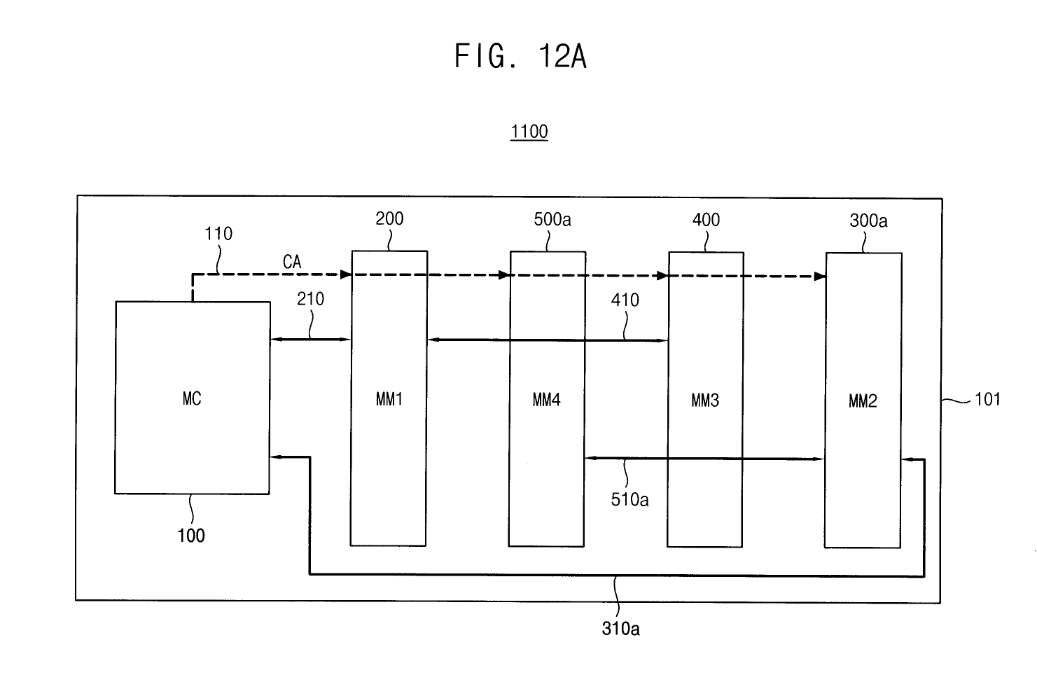

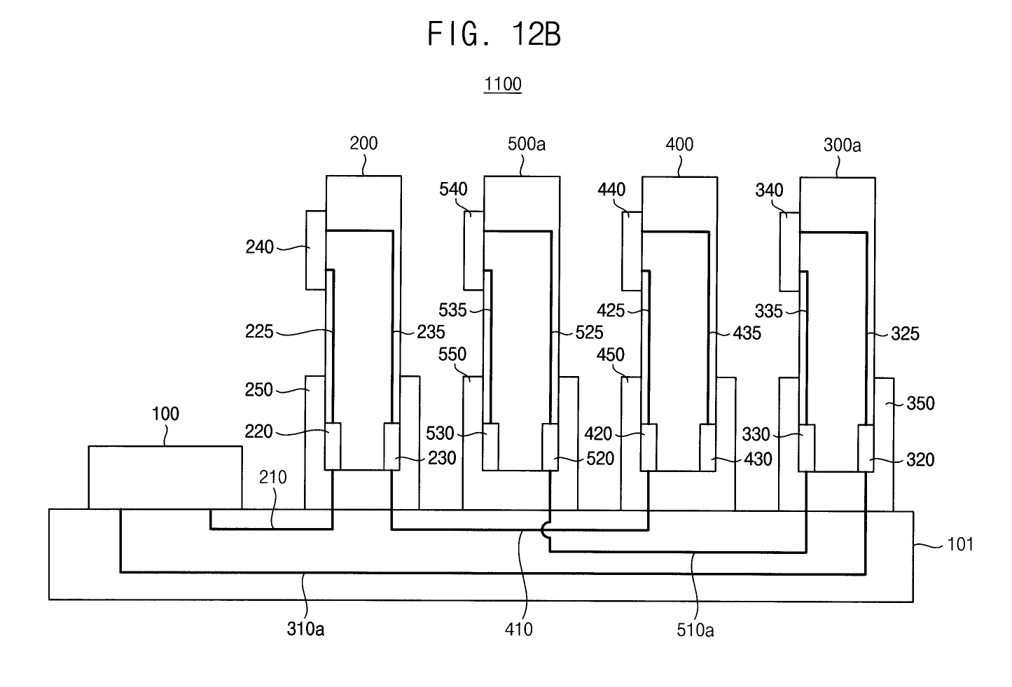

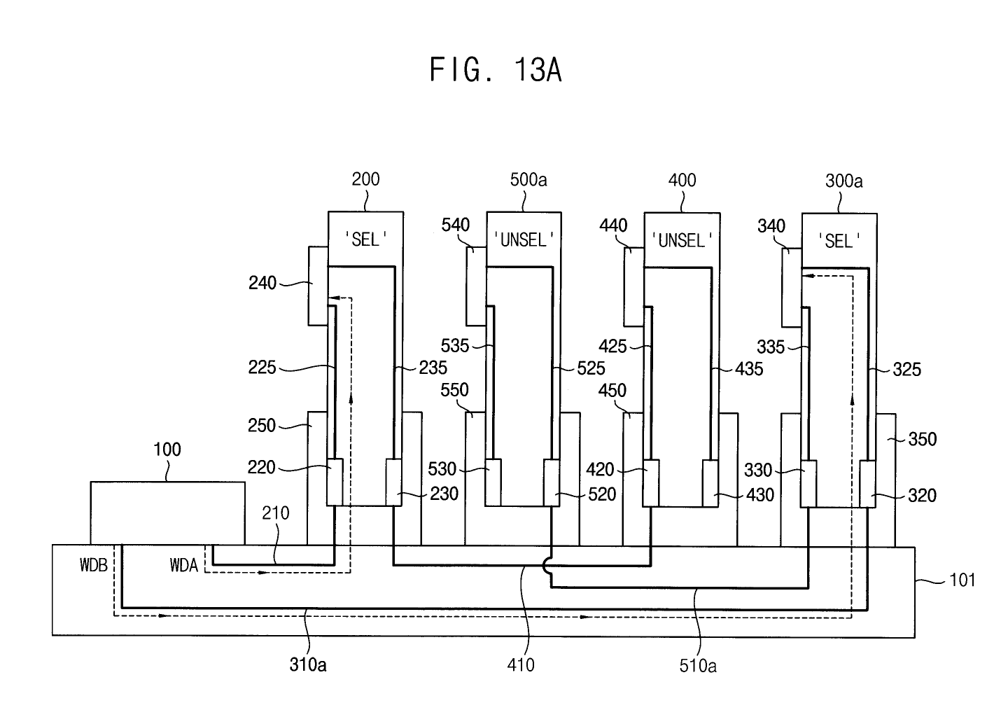

FIGS. 12A and 12B are diagrams illustrating a memory system according to additional example embodiments. FIG. 12A is a plan view of a memory system according to other example embodiment. FIG. 12B is an exemplary cross-sectional view of the memory system of FIG. 12A.

Referring to FIGS. 12A and 12B, a memory system 1100 includes a memory controller 100, a first memory module 200, a second memory module 300a, a third memory module 400 and a fourth memory module 500a that are mounted on a base substrate 101.

In comparison with the memory system 1000 of FIGS. 1A and 1B, the locations of the second memory module 300a and the fourth memory module 500a may be changed in the memory system 1100 of FIGS. 12A and 12B. As such, a distance between the memory controller 100 and the second memory module 300 (e.g., a module that it is directly electrically connected to) may be shorter than a distance between the memory controller 100 and the fourth memory module 500 in FIGS. 1A and 1B, however, a distance between the memory controller 100 and the second memory module 300a may be longer than a distance between the memory controller 100 and the fourth memory module 500a in FIGS. 12A and 12B. Internal arrangements (e.g., the data I/O pins 320, 330, 520 and 530, and the internal data lines 325, 335, 525 and 535) of the second and fourth memory modules 300a and 500a in FIG. 12B may be symmetrically changed with respect to the internal arrangements of the second and fourth memory modules 300 and 500 in FIG. 1B, respectively. Second and fourth memory buses 310a and 510a in FIGS. 12A and 12B may be different from the second and fourth memory buses 310 and 510 in FIGS. 1A and 1B, respectively.

Although not illustrated in FIGS. 12A and 12B, the locations of the first memory module and the third memory modules may also be changed according to example embodiments.

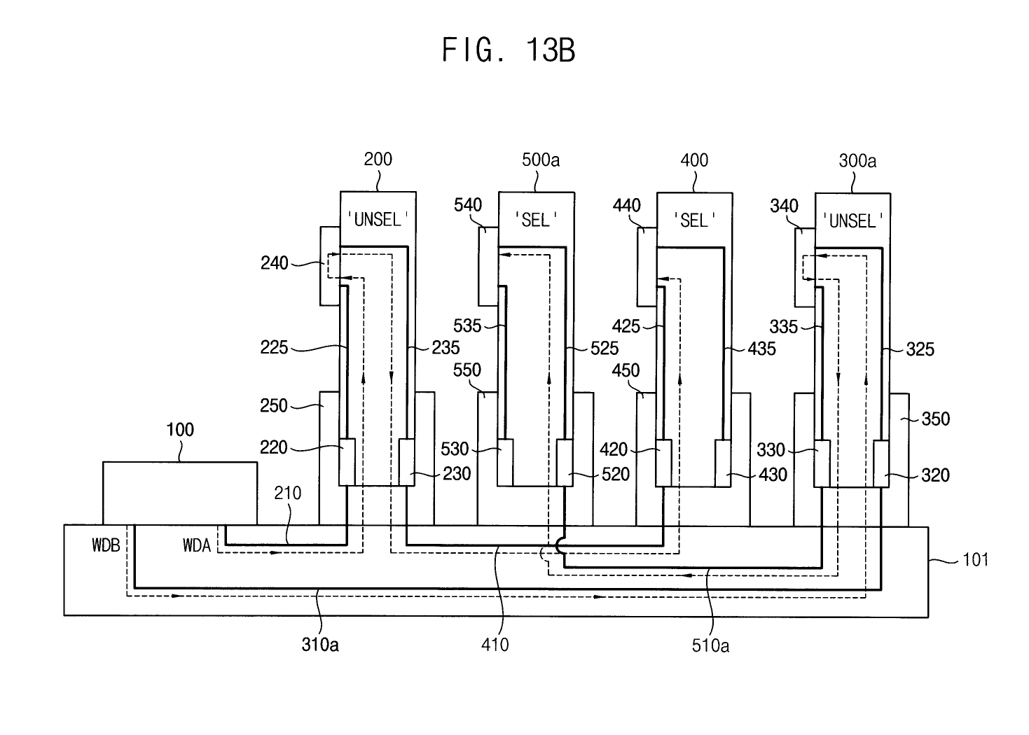

FIGS. 13A and 13B are diagrams for describing exemplary operations of the memory system of FIGS. 12A and 12B.

FIG. 13A illustrates a write operation based on the first and second memory modules 200 and 300a. FIG. 13B illustrates a write operation based on the third and fourth memory modules 400 and 500a. In FIGS. 13A and 13B, ‘SEL’ indicates a selected memory module and ‘UNSEL’ indicates an unselected memory module.

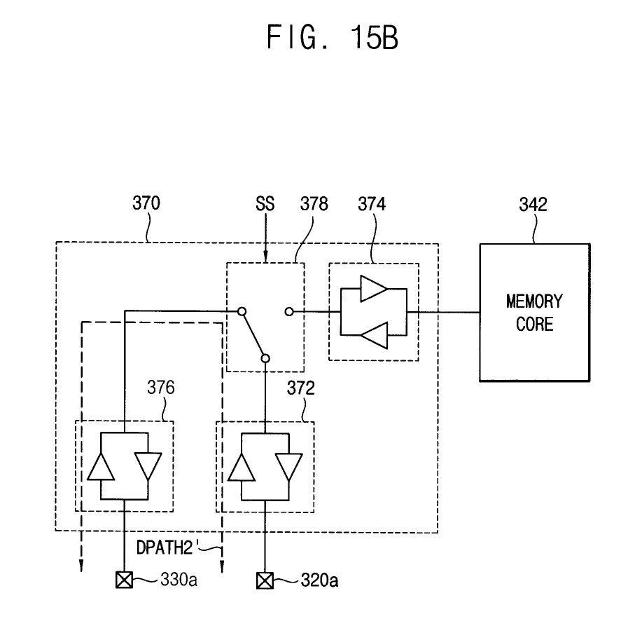

Referring to FIG. 13A, the memory controller 100 selects the first memory module 200 and the second memory module 300a based on the selection signal. During the write mode, the memory controller 100 may store the first write data WDA of the write data in the first memory module 200 (e.g., the first selected memory module) and may store the second write data WDB of the write data in the second memory module 300a (e.g., the second selected memory module). The data I/O buffer unit included in the first memory module 200 may operate, for example, as illustrated in FIG. 9A. In one embodiment, the operation of the data I/O buffer unit included in the second memory module 300a may be as described below with reference to FIG. 15A.

In example embodiments, the third and fourth memory modules 400 and 500a may be disabled based on the selection signal. Although not illustrated in FIG. 13A, during the read mode, the memory controller 100 may read the first read data RDA of the read data from the first memory module 200 and may read the second read data RDB of the read data from the second memory module 300a.

Referring to FIG. 13B, the memory controller 100 selects the third memory module 400 and the fourth memory module 500a based on the selection signal. During the write mode, the memory controller 100 may store the first write data WDA of the write data in the third memory module 400 (e.g., the first selected memory module) and may store the second write data WDB of the write data in the fourth memory module 500a (e.g., the second selected memory module). The data I/O buffer unit included in the first memory module 200 may operate, for example, as illustrated in FIG. 9B. In one embodiment, the operation of the data I/O buffer unit included in the second memory module 300a may be as described below with reference to FIG. 15B.

In example embodiments, the first and second memory modules 200 and 300a may be partially disabled based on the selection signal. Although not illustrated in FIG. 13B, during the read mode, the memory controller 100 may read the first read data RDA of the read data from the third memory module 400 and may read the second read data RDB of the read data from the fourth memory module 500a.

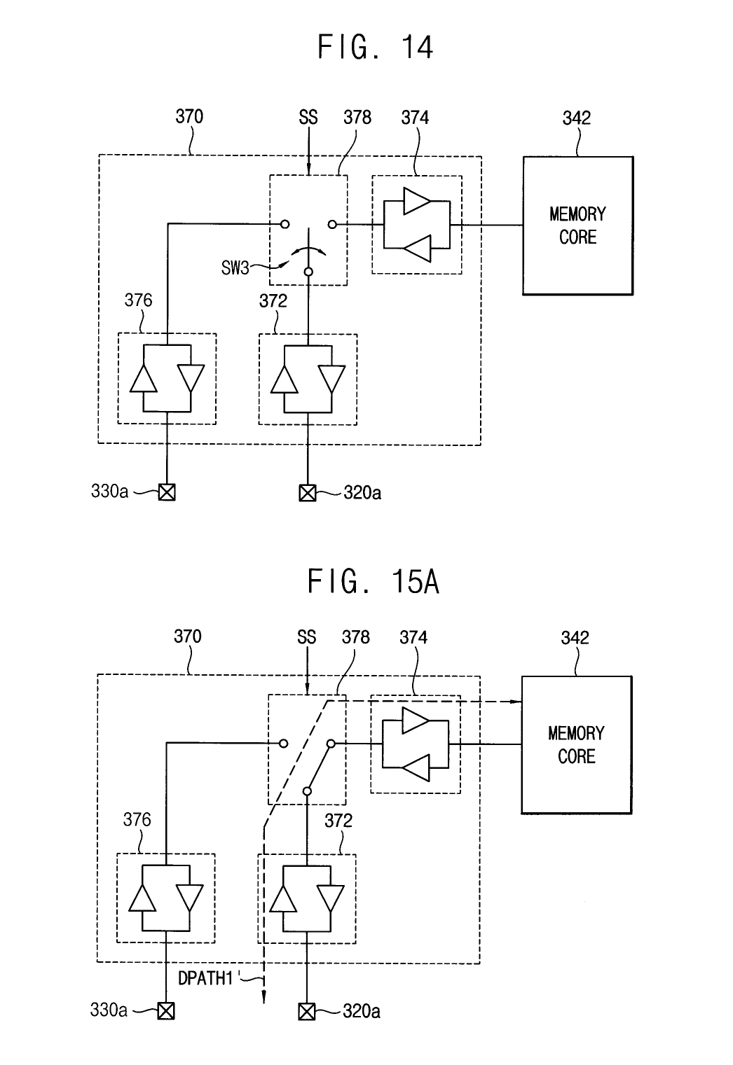

FIG. 14 is a block diagram illustrating an example of a data I/O buffer unit included in a second memory module in FIGS. 12A and 12B. FIGS. 15A and 15B are diagrams for describing exemplary operations of the data I/O buffer unit of FIG. 14.

Referring to FIGS. 14, 15A and 15B, a data I/O buffer unit 370 may include a first buffer unit 372, a second buffer unit 374, a third buffer unit 376 and a path selection unit 378.

In comparison with the data I/O buffer unit 270 of FIG. 8, the locations of the first buffer unit 372 and the third buffer unit 376 may be changed in the data I/O buffer unit 370 of FIG. 14 because the locations of pins 320a and 330a in FIG. 14 are different from the locations of the pins 220a and 230a in FIG. 8.

The first buffer unit 372 may be connected to one (e.g. the pin 320a) of the plurality of first data I/O pins 320. The second buffer unit 374 may be connected to the memory core 342. The third buffer unit 376 may be connected to one (e.g., the pin 330a) of the plurality of second data I/O pins 330.

The path selection unit 378 may connect one of the second buffer unit 374 and the third buffer unit 376 to the first buffer unit 372 based on the selection signal SS. The path selection unit 378 may include, for example, a third switch SW3. One of first path DPATH1′ and second path DPATH2′ may be selectively enabled based on the selection signal SS. For example, when the second memory module 300a is selected as the second selected memory module, the path selection unit 378 may electrically connect the second buffer unit 374 to the first buffer unit 372, and thus the first path DPATH1′ may be enabled, as illustrated in FIG. 15A. For another example, when the fourth memory module 500 is selected as the second selected memory module, the path selection unit 378 may electrically connect the third buffer unit 376 to the first buffer unit 372, and thus the second path DPATH2′ may be enabled, as illustrated in FIG. 15B.

Although not illustrated in FIGS. 14, 15A and 15B, the data I/O buffer unit included in the second memory module 300a in FIGS. 12A and 12B may have a structure similar to the data I/O buffer unit 270a of FIG. 10, which further includes a fourth buffer unit.

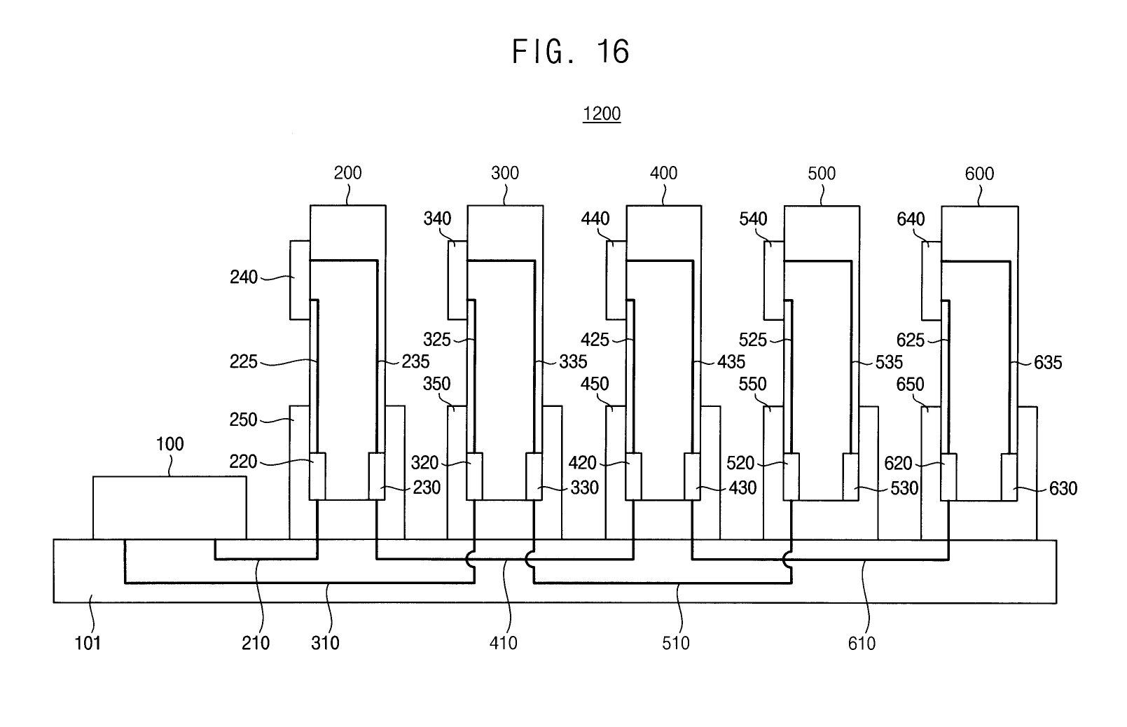

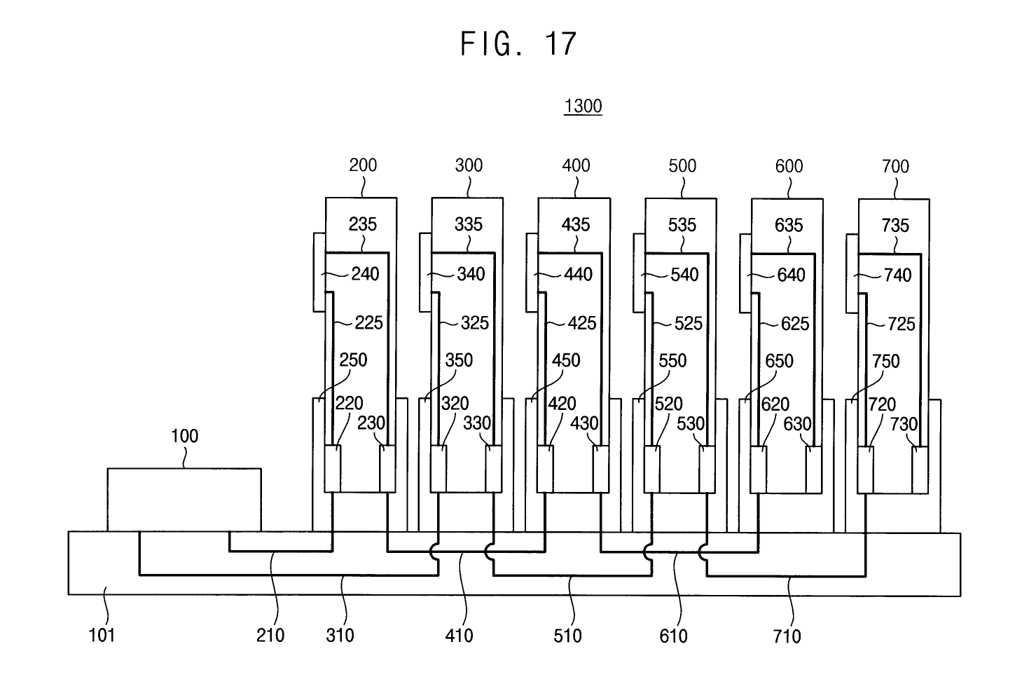

FIGS. 16 and 17 are diagrams illustrating memory systems according to example embodiments.

Referring to FIG. 16, a memory system 1200 includes a memory controller 100, a first memory module 200, a second memory module 300, a third memory module 400, a fourth memory module 500 and a fifth memory module 600 that are mounted on a base substrate 101.

In comparison with the memory system 1000 of FIGS. 1A and 1B, the memory system 1200 of FIG. 16 may further include the fifth memory module 600. A socket 650 may be further formed on the base substrate 101, and the fifth memory module 600 may be inserted in the fifth socket 650. The fifth memory module 600 may be connected to the third memory module 400 through a fifth memory bus 610. The fifth memory module 600 may exchange the first data with the memory controller 100 through the first memory bus 210, the third memory bus 410 and the fifth memory bus 610. As such, the fifth memory module 600 may be indirectly connected to the memory controller 100 through the first, third and fifth memory buses 210, 410 and 610. The fifth memory module 600 may include a plurality of first data I/O pins 620 that are connected to the fifth memory bus 610, a plurality of second data I/O pins 630, and a volatile memory device 640 that is connected to the plurality of first data I/O pins 620 through first internal data lines 625 and is connected to the plurality of second data I/O pins 630 through second internal data lines 635.

In the memory system 1200 of FIG. 16, the first memory module group may include the first, third and fifth memory modules 200, 400 and 600, and the second memory module group may include the second and fourth memory modules 300 and 500. If each memory module is the ×64 DIMM, the memory system 1200 may have the structure of “×32 per DIMM” and a structure of “5DPC.”

Although not illustrated in FIG. 16, in an alternate embodiment, the fifth memory module 600 may be connected to the fourth memory module 500 through a fifth memory bus (not shown), and may exchange the second data with the memory controller 100 through the second, fourth and fifth memory buses. As such, the first memory module group may include the first and third memory modules, and the second memory module group may include the second, fourth and fifth memory modules.

Referring to FIG. 17, a memory system 1300 includes a memory controller 100, a first memory module 200, a second memory module 300, a third memory module 400, a fourth memory module 500, a fifth memory module 600 and a sixth memory module 700 that are mounted on a base substrate 101.

In comparison with the memory system 1200 of FIG. 16, the memory system 1300 of FIG. 17 may further include the sixth memory module 700. A socket 750 may be further formed on the base substrate 101, and the sixth memory module 700 may be inserted in the sixth socket 750. The sixth memory module 700 may be connected to the fourth memory module 500 through a sixth memory bus 710. The sixth memory module 700 may exchange the second data with the memory controller 100 through the second memory bus 310, the fourth memory bus 510 and the sixth memory bus 710. As such, the sixth memory module 700 may be indirectly connected to the memory controller 100 through the second, fourth and sixth memory buses 310, 510 and 710. The sixth memory module 700 may include a plurality of first data I/O pins 720 that are connected to the sixth memory bus 710, a plurality of second data I/O pins 730, and a volatile memory device 740 that is connected to the plurality of first data I/O pins 720 through first internal data lines 725 and is connected to the plurality of second data I/O pins 730 through second internal data lines 735.

In the memory system 1300 of FIG. 17, the first memory module group may include the first, third and fifth memory modules 200, 400 and 600, and the second memory module group may include the second, fourth and sixth memory modules 300, 500 and 700. If each memory module is the ×64 DIMM, the memory system 1300 may have the structure of “×32 per DIMM” and a structure of “6DPC.”

As described above, the number of memory modules included in the first memory module group may be different from (e.g., the embodiment of FIG. 16) or the same as (e.g., the embodiment of FIG. 17) the number of memory modules included in the second memory module group, and the total number of the memory modules may be an odd number (e.g., the embodiment of FIG. 16) or an even number (e.g., the embodiment of FIG. 17). In other words, the number of the memory modules included in the memory system according to example embodiments may be not limited to 2^{m}, where m is zero or a positive integer, and a single channel included in the memory system according to example embodiments may be implemented with an odd-numbered or an even-numbered amount of memory modules.

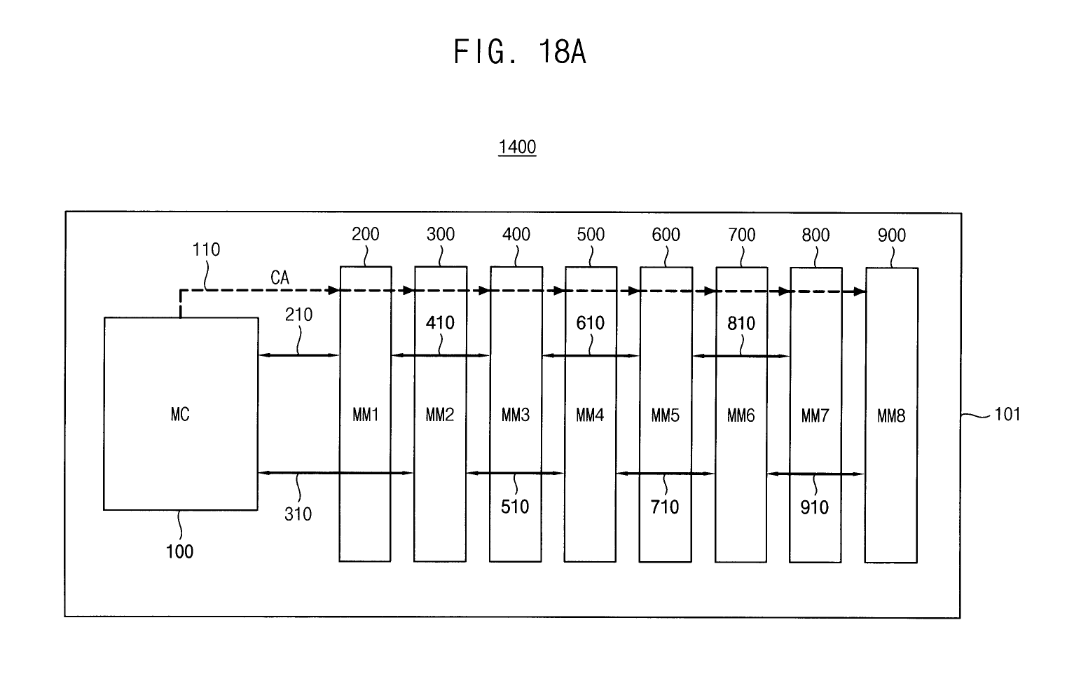

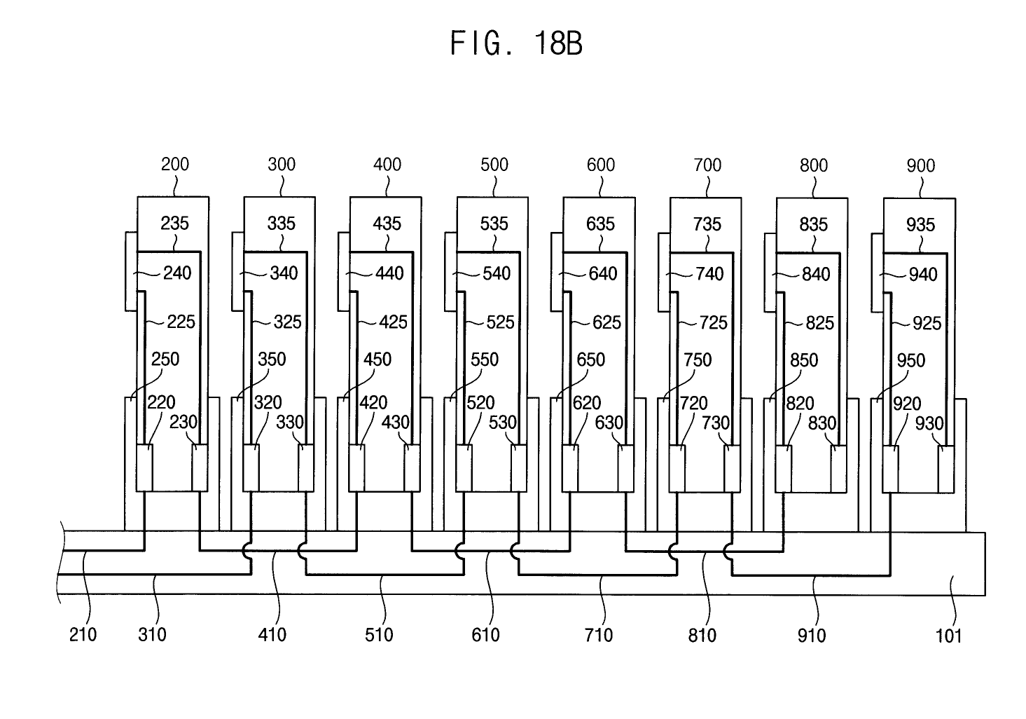

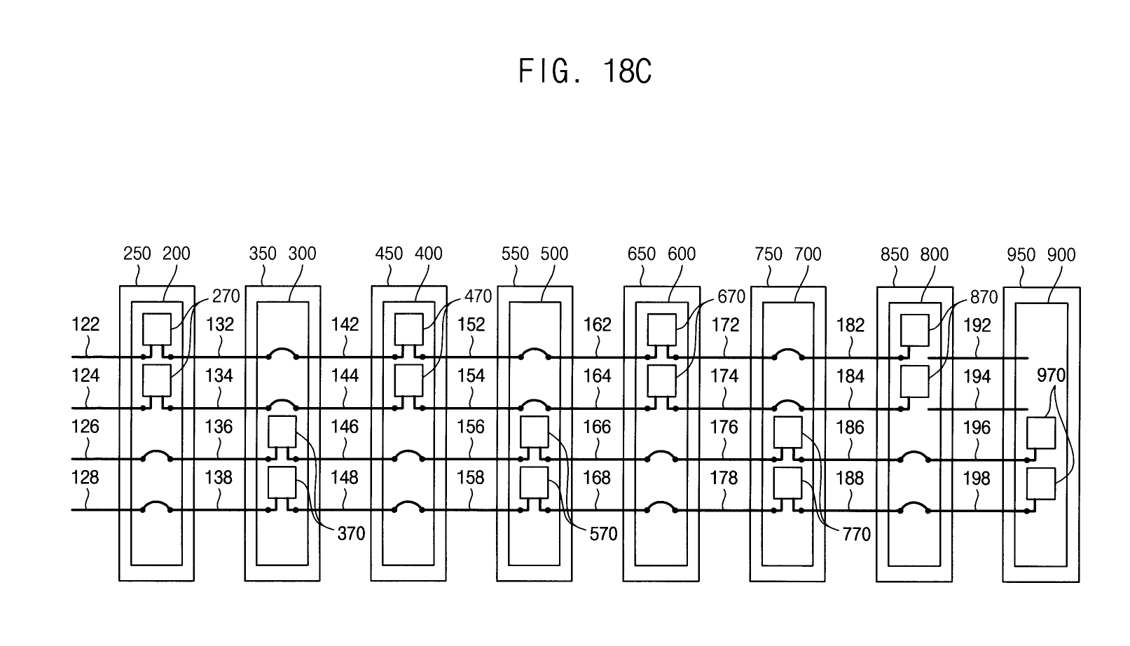

FIGS. 18A and 18B are diagrams illustrating a memory system according to additional example embodiments. FIG. 18A is a plan view of a memory system according to still other example embodiment. FIG. 18B is an exemplary cross-sectional view of the memory system of FIG. 18A. For convenience of illustration, the memory controller is omitted in FIG. 18B.

Referring to FIGS. 18A and 18B, a memory system 1400 includes a memory controller 100, a first memory module 200, a second memory module 300, a third memory module 400, a fourth memory module 500, a fifth memory module 600, a sixth memory module 700, a seventh memory module 800 and an eighth memory module 900 that are mounted on a base substrate 101.

In comparison with the memory system 1300 of FIG. 17, the memory system 1400 of FIGS. 18A and 18B may further include the seventh memory module 800 and the eighth memory module 900. Sockets 850 and 950 may be further formed on the base substrate 101. The seventh memory module 800 may be inserted in the seventh socket 850, and the eighth memory module 900 may be inserted in the eighth socket 950. The seventh memory module 800 may be connected to the fifth memory module 600 through a seventh memory bus 810. The seventh memory module 800 may exchange the first data with the memory controller 100 through the first memory bus 210, the third memory bus 410, the fifth memory bus 610 and the seventh memory bus 810. As such, the seventh memory module 800 may be indirectly connected to the memory controller 100 through the first, third, fifth and seventh memory buses 210, 410, 610 and 810. The eighth memory module 900 may be connected to the sixth memory module 700 through an eighth memory bus 910. The eighth memory module 900 may exchange the second data with the memory controller 100 through the second memory bus 310, the fourth memory bus 510, the sixth memory bus 710 and the eighth memory bus 910. As such, the eighth memory module 900 may be indirectly connected to the memory controller 100 through the second, fourth, sixth and eighth memory buses 310, 510, 710 and 910.

The seventh memory module 800 may include a plurality of first data I/O pins 820 that are connected to the seventh memory bus 810, a plurality of second data I/O pins 830, and a volatile memory device 840 that is connected to the plurality of first data I/O pins 820 through first internal data lines 825 and is connected to the plurality of second data I/O pins 830 through second internal data lines 835. The eighth memory module 900 may include a plurality of first data I/O pins 920 that are connected to the eighth memory bus 910, a plurality of second data I/O pins 930, and a volatile memory device 940 that is connected to the plurality of first data I/O pins 920 through first internal data lines 925 and is connected to the plurality of second data I/O pins 930 through second internal data lines 935.

In the memory system 1400 of FIGS. 18A and 18B, the first memory module group may include the first, third, fifth and seventh memory modules 200, 400, 600 and 800, and the second memory module group may include the second, fourth, sixth and eighth memory modules 300, 500, 700 and 900. If each memory module is the ×64 DIMM, the memory system 1400 may have the structure of “×32 per DIMM” and a structure of “8DPC.”

FIG. 18C is a diagram for describing an exemplary structure of the memory system of FIGS. 18A and 18B. For convenience of illustration, the memory controller is omitted in FIG. 18C.

Referring to FIGS. 18A, 18B and 18C, a plurality of data line sets 122, 124, 126, 128, 132, 134, 136, 138, 142, 144, 146, 148, 152, 154, 156, 158, 162, 164, 166, 168, 172, 174, 176, 178, 182, 184, 186, 188, 192, 194, 196 and 198 may be formed on and/or in the base substrate 101. The first, second, third, fourth, fifth, sixth, seventh and eighth memory buses 210, 310, 410, 510, 610, 710, 810 and 910 may be provided by selectively open-circuiting or short-circuiting the plurality of data line sets 122, 124, 126, 128, 132, 134, 136, 138, 142, 144, 146, 148, 152, 154, 156, 158, 162, 164, 166, 168, 172, 174, 176, 178, 182, 184, 186, 188, 192, 194, 196 and 198.

In detail, the first, second, third and fourth memory buses 210, 310, 410 and 510 may be provided as described above with reference to FIG. 4. The fifth memory bus 610 may be provided by electrically connecting each of data line sets 152 and 154 to the respective one of data I/O buffer units 470, by electrically connecting the data line set 152 to a data line set 162, by electrically connecting the data line set 154 to a data line set 164, and by electrically connecting each of the data line sets 162 and 164 to a respective one of data I/O buffer units 670 that is included in the fifth memory module 600. The sixth memory bus 710 may be provided by electrically connecting each of data line sets 166 and 168 to the respective one of data I/O buffer units 570, by electrically connecting the data line set 166 to a data line set 176, by electrically connecting the data line set 168 to a data line set 178, and by electrically connecting each of the data line sets 176 and 178 to a respective one of data I/O buffer units 770 that is included in the sixth memory module 700. The seventh memory bus 810 may be provided by electrically connecting each of data line sets 172 and 174 to the respective one of data I/O buffer units 670, by electrically connecting the data line set 172 to a data line set 182, by electrically connecting the data line set 174 to a data line set 184, and by electrically connecting each of the data line sets 182 and 184 to a respective one of data I/O buffer units 870 that is included in the seventh memory module 800. The eighth memory bus 910 may be provided by electrically connecting each of data line sets 186 and 188 to the respective one of data I/O buffer units 770, by electrically connecting the data line set 186 to a data line set 196, by electrically connecting the data line set 188 to a data line set 198, and by electrically connecting each of the data line sets 196 and 198 to a respective one of data I/O buffer units 970 that is included in the eighth memory module 900. Data line sets 192 and 194 may be electrically opened (e.g., the open-circuiting), respectively.

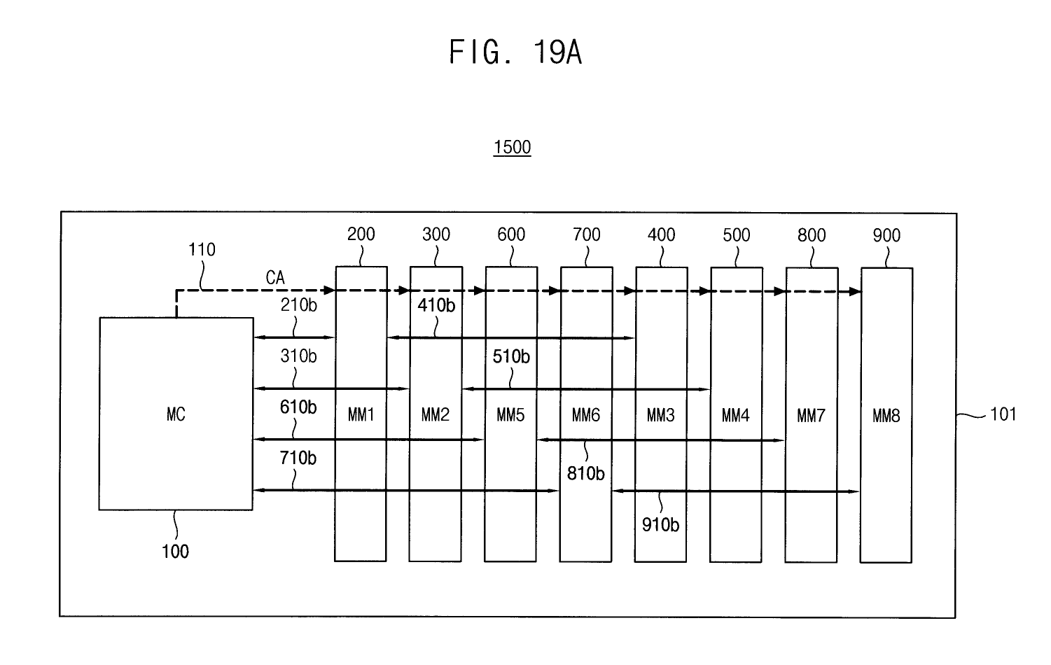

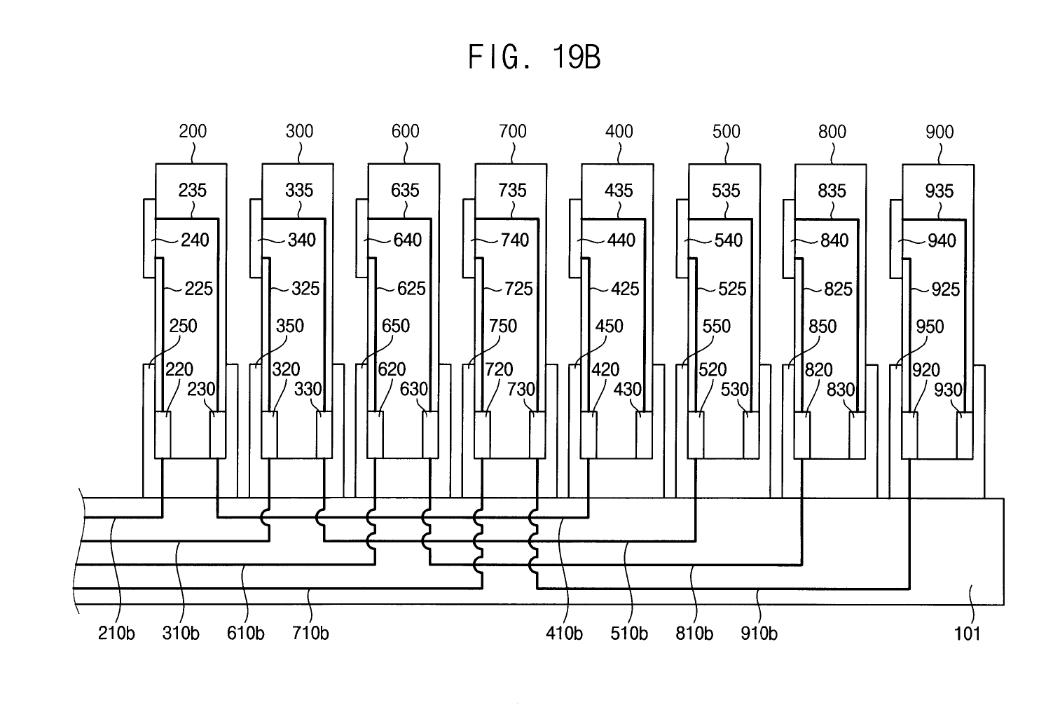

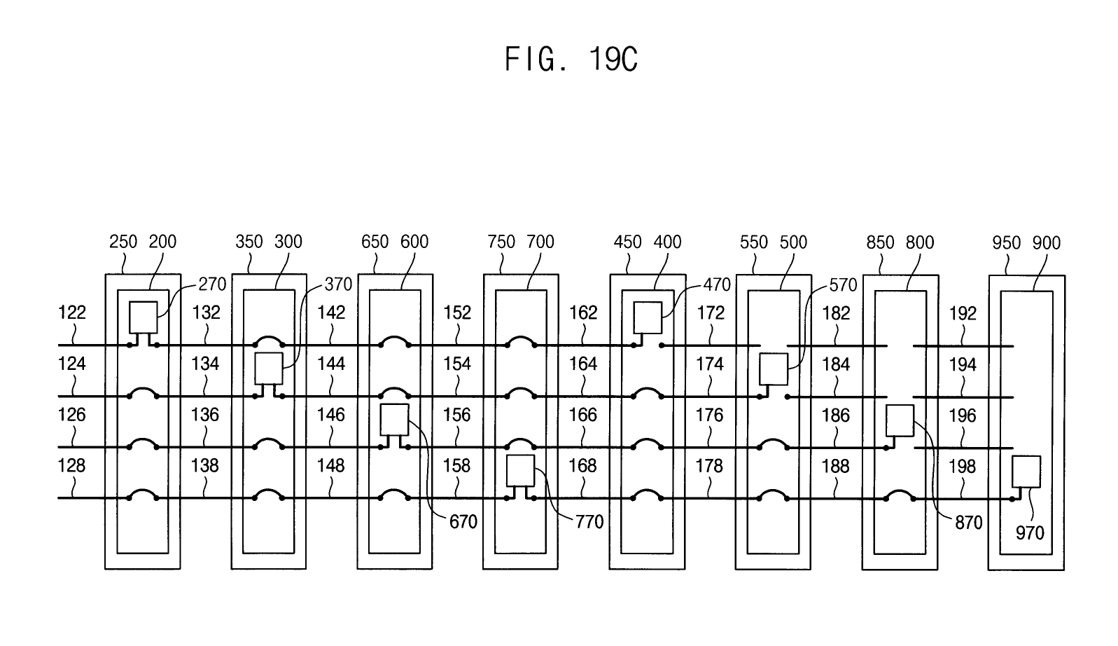

FIGS. 19A and 19B are diagrams illustrating a memory system according to further example embodiments. FIG. 19A is a plan view of a memory system according to one example embodiment. FIG. 19B is an exemplary cross-sectional view of the memory system of FIG. 19A. For convenience of illustration, a memory controller is omitted in FIG. 19B.

Referring to FIGS. 19A and 19B, a memory system 1500 includes a memory controller 100, a first memory module 200, a second memory module 300, a third memory module 400, a fourth memory module 500, a fifth memory module 600, a sixth memory module 700, a seventh memory module 800 and an eighth memory module 900 that are mounted on a base substrate 101.

In comparison with the memory system 1400 of FIGS. 18A and 18B, the locations of the third memory module 400 and the fifth memory module 600 may be changed, and the locations of the fourth memory module 500 and the sixth memory module 700 may be changed in the memory system 1500 of FIGS. 19A and 19B. In addition, memory buses 210b, 310b, 410b, 510b, 610b, 710b, 810b and 910b in FIGS. 19A and 19B may be different from the memory buses 210, 310, 410, 510, 610, 710, 810 and 910 in FIGS. 18A and 18B, respectively. Internal arrangements of the memory modules 200, 300, 400, 500, 600, 700, 800 and 900 in FIGS. 19A and 19B may be substantially the same as the internal arrangements of the memory modules 200, 300, 400, 500, 600, 700, 800 and 900 in FIGS. 198 and 18B, respectively.

The first memory module 200 may exchange first data with the memory controller 100 through the first memory bus 210b. The second memory module 300 may exchange second data with the memory controller 100 through the second memory bus 310b. The fifth memory module 600 may exchange third data with the memory controller 100 through the fifth memory bus 610b. The sixth memory module 700 may exchange fourth data with the memory controller 100 through the sixth memory bus 710b. The first, second, fifth and sixth memory modules 200, 300, 600 and 700 may be directly connected to the memory controller 100, respectively. The first, second, third and fourth data may be included in a plurality of data that are simultaneously provided.

The third memory module 400 may exchange the first data with the memory controller 100 through the first and third memory bus 210b and 410b. The fourth memory module 500 may exchange the second data with the memory controller 100 through the second and fourth memory bus 310b and 510b. The seventh memory module 800 may exchange the third data with the memory controller 100 through the fifth and seventh memory bus 610b and 810b. The eighth memory module 900 may exchange the fourth data with the memory controller 100 through the sixth and eighth memory bus 710b and 910b. The third, fourth, seventh and eighth memory modules 400, 500, 800 and 900 may be indirectly connected to the memory controller 100, respectively.

In example embodiments, the memory modules 200, 300, 400, 500, 600, 700, 800 and 900 may be divided into a first memory module group, a second memory module group, a third memory module group, and a fourth memory module group. The first memory module group may include the first and third memory modules 200 and 400, and one of the first and third memory modules 200 and 400 may be selected as a first selected memory module based on the selection signal. The second memory module group may include the second and fourth memory modules 300 and 500, and one of the second and fourth memory modules 300 and 500 may be selected as a second selected memory module based on the selection signal. The third memory module group may include the fifth and seventh memory modules 600 and 800, and one of the fifth and seventh memory modules 600 and 800 may be selected as a third selected memory module based on the selection signal. The fourth memory module group may include the sixth and eighth memory modules 700 and 900, and one of the sixth and eighth memory modules 700 and 900 may be selected as a fourth selected memory module based on the selection signal. The memory controller 100 may perform the write operation or the read operation based on the first, second, third and fourth selected memory modules.

In example embodiments, if each memory module is the ×64 DIMM, each of the first, second, third and fourth data may correspond to 16-bit data, and the memory system 1500 may have the structure of “×16 per DIMM” and the structure of “8DPC.”

FIG. 19C is a diagram for describing an exemplary structure of the memory system of FIGS. 19A and 19B. For convenience of illustration, the memory controller is omitted in FIG. 19C.

Referring to FIGS. 19A, 19B and 19C, the first, second, third, fourth, fifth, sixth, seventh and eighth memory buses 210b, 310b, 410b, 510b, 610b, 710b, 810b and 910b may be provided by selectively open-circuiting or short-circuiting a plurality of data line sets 122, 124, 126, 128, 132, 134, 136, 138, 142, 144, 146, 148, 152, 154, 156, 158, 162, 164, 166, 168, 172, 174, 176, 178, 182, 184, 186, 188, 192, 194, 196 and 198.

In detail, the first memory bus 210b may be provided by electrically connecting (e.g., the short-circuiting) a data line set 122 to a data I/O buffer unit 270 that is included in the first memory module 200. The second memory bus 310b may be provided by electrically connecting a data line set 124 to a data line set 134, and by electrically connecting the data line set 134 to a data I/O buffer unit 370 that is included in the second memory module 300. The fifth memory bus 610b may be provided by electrically connecting a data line set 126 to a data line set 136, by electrically connecting the data line set 136 to a data line set 146, and by electrically connecting the data line set 146 to a data I/O buffer unit 670 that is included in the fifth memory module 600. The sixth memory bus 710b may be provided by electrically connecting a data line set 128 to a data line set 138, by electrically connecting the data line set 138 to a data line set 148, by electrically connecting the data line set 148 to a data line set 158, and by electrically connecting the data line set 158 to a data I/O buffer unit 770 that is included in the sixth memory module 700.

The third memory bus 410b may be provided by electrically connecting a data line set 132 to the data I/O buffer unit 270, by electrically connecting the data line set 132 to a data line set 142, by electrically connecting the data line set 142 to a data line set 152, by electrically connecting the data line set 152 to a data line set 162, and by electrically connecting the data line set 162 to a data I/O buffer unit 470 that is included in the third memory module 400. The fourth memory bus 510b may be provided by electrically connecting a data line set 144 to the data I/O buffer unit 370, by electrically connecting the data line set 144 to a data line set 154, by electrically connecting the data line set 154 to a data line set 164, by electrically connecting the data line set 164 to a data line set 174, and by electrically connecting the data line set 174 to a data I/O buffer unit 570 that is included in the fourth memory module 500. The seventh memory bus 810b may be provided by electrically connecting a data line set 156 to the data I/O buffer unit 670, by electrically connecting the data line set 156 to a data line set 166, by electrically connecting the data line set 166 to a data line set 176, by electrically connecting the data line set 176 to a data line set 186, and by electrically connecting the data line set 186 to a data I/O buffer unit 870 that is included in the seventh memory module 800. The eighth memory bus 910b may be provided by electrically connecting a data line set 168 to the data I/O buffer unit 770, by electrically connecting the data line set 168 to a data line set 178, by electrically connecting the data line set 178 to a data line set 188, by electrically connecting the data line set 188 to a data line set 198, and by electrically connecting the data line set 198 to a data I/O buffer unit 970 that is included in the eighth memory module 900. Data line sets 172, 182, 184, 192, 194 and 196 may be electrically opened (e.g., open-circuiting), respectively.

As described above with reference to FIGS. 4, 11A, 11B and 11C, the structure of the memory system according to example embodiments may be determined as one of structures illustrated in FIGS. 18C and 19C based on the MRS command or the BIOS command, and/or the structure of the memory system according to example embodiments may be changed from one of structures illustrated in FIGS. 18C and 19C to another one of structures illustrated in FIGS. 18C and 19C based on the MRS command or the BIOS command.

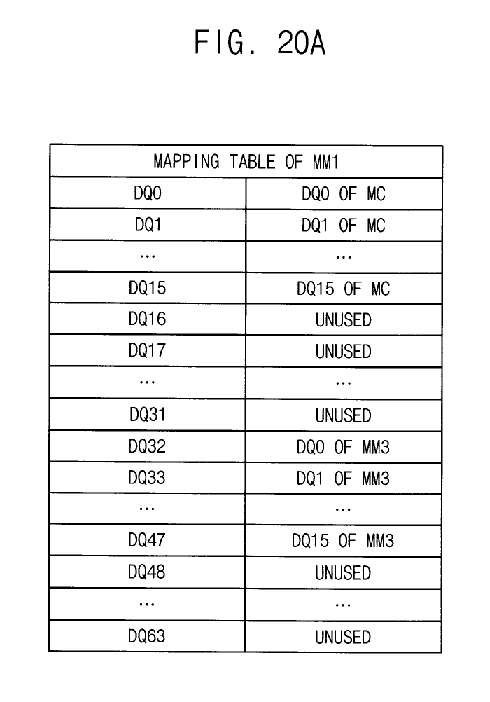

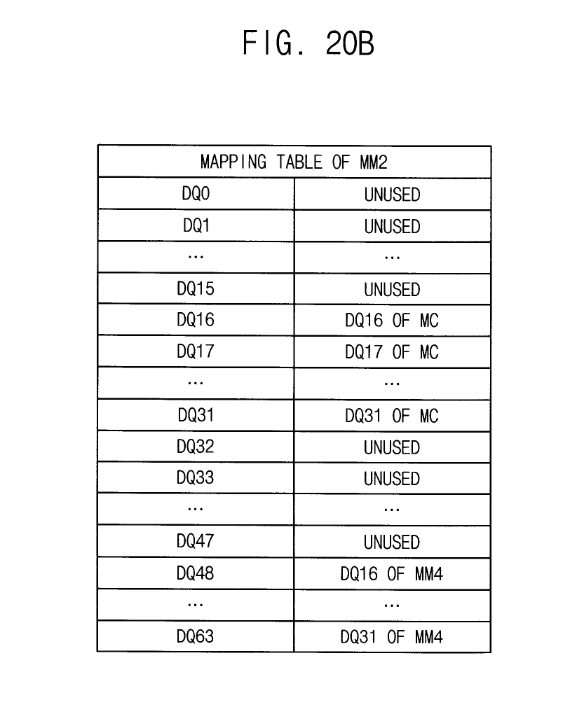

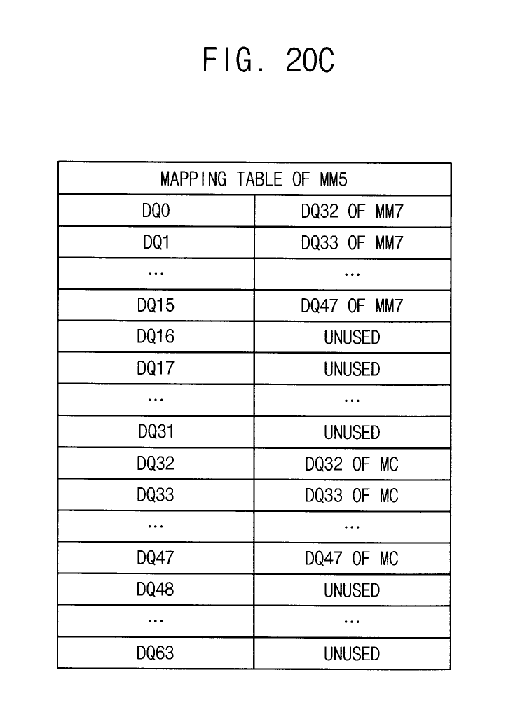

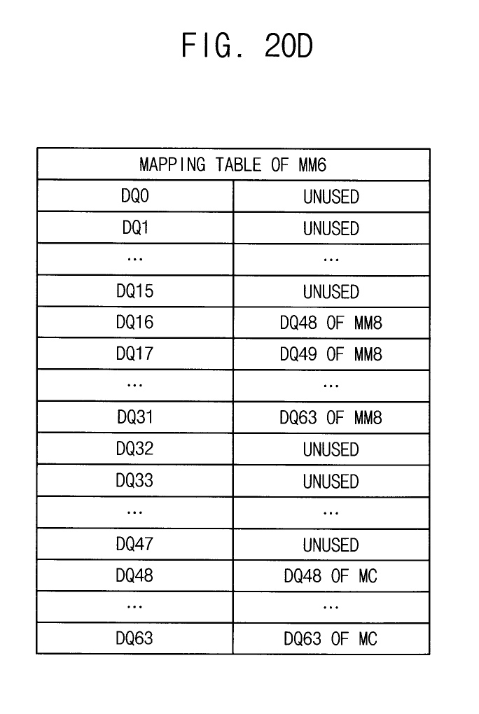

FIGS. 20A, 20B, 20C and 20D are tables for describing exemplary connections of the data I/O pins in the memory system of FIGS. 19A and 19B. In FIGS. 20A, 20B, 20C and 20D, it is assumed that each memory module is ×64 DIMM.

Referring to FIGS. 20A, 20B, 20C and 20D, the first memory module group including the first and third memory modules 200 and 400 may exchange first lower 16-bit data of 64-bit data with the memory controller 100. The second memory module group including the second and fourth memory modules 300 and 500 may exchange second lower 16-bit data of the 64-bit data with the memory controller 100. The third memory module group including the fifth and seventh memory modules 600 and 800 may exchange first upper 16-bit data of the 64-bit data with the memory controller 100. The fourth memory module group including the sixth and eighth memory modules 700 and 900 may exchange second upper 16-bit data of the 64-bit data with the memory controller 100. The second lower 16-bit data may be higher than the first lower 16-bit data, the first upper 16-bit data may be higher than the second lower 16-bit data, and the second upper 16-bit data may be higher than the first upper 16-bit data.

In detail, each of first lower bit I/O pins DQ0, DQ1, . . . , DQ15 of the first memory module 200 may be connected to a respective one of first lower bit I/O pins DQ0, DQ1, . . . , DQ15 of the memory controller 100. Each of first upper bit I/O pins DQ32, DQ33, . . . , DQ47 of the first memory module 200 may be connected to a respective one of first lower bit I/O pins DQ0, DQ1, . . . , DQ15 of the third memory module 400. Each of second lower bit I/O pins DQ16, DQ17, . . . , DQ31 of the second memory module 300 may be connected to a respective one of second lower bit I/O pins DQ16, DQ17, . . . , DQ31 of the memory controller 100. Each of second upper bit I/O pins DQ48, . . . , DQ63 of the second memory module 300 may be connected to a respective one of second lower bit I/O pins DQ16, . . . , DQ31 of the fourth memory module 500. Each of first upper bit I/O pins DQ32, DQ33, . . . , DQ47 of the fifth memory module 600 may be connected to a respective one of first upper bit I/O pins DQ32, DQ33, . . . , DQ47 of the memory controller 100. Each of first lower bit I/O pins DQ0, DQ1, . . . , DQ15 of the fifth memory module 600 may be connected to a respective one of first upper bit I/O pins DQ32, DQ33, . . . , DQ47 of the seventh memory module 800. Each of second upper bit I/O pins DQ48, . . . , DQ63 of the sixth memory module 700 may be connected to a respective one of second upper bit I/O pins DQ48, . . . , DQ63 of the memory controller 100. Each of second lower bit I/O pins DQ16, DQ17, . . . , DQ31 of the sixth memory module 700 may be connected to a respective one of second upper bit I/O pins DQ48, DQ49, . . . , DQ63 of the eighth memory module 900.

Second lower bit I/O pins DQ16, DQ17, . . . , DQ31 and second upper bit I/O pins DQ48, . . . , DQ63 of the first and fifth memory modules 200 and 600 may be not used. First lower bit I/O pins DQ0, DQ1, . . . , DQ15 and first upper bit I/O pins DQ32, DQ33, . . . , DQ47 of the second and sixth memory modules 300 and 700 may be not used. Such unused pins in the memory modules 200, 300, 600 and 700 may be disabled based on the selection signal.

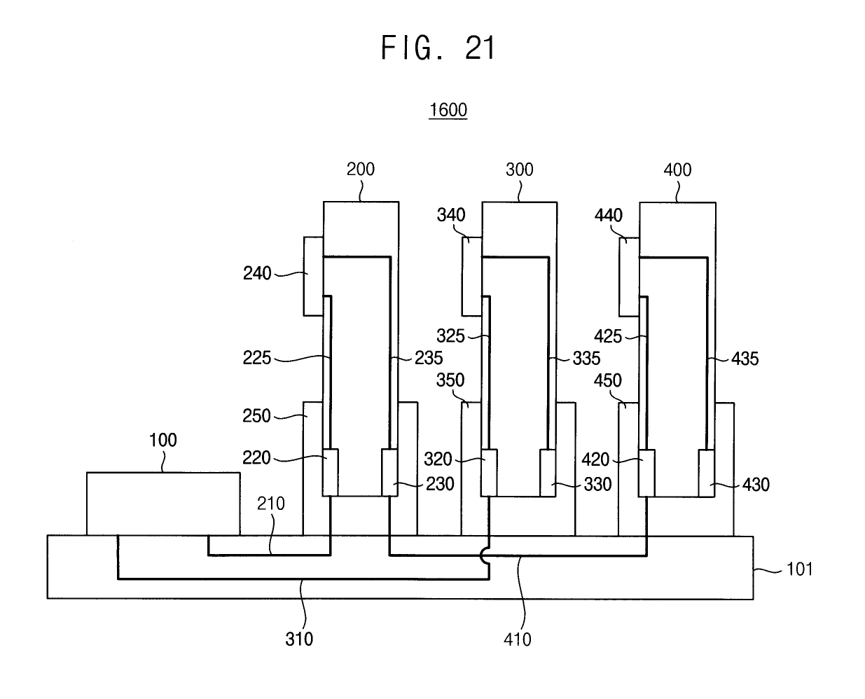

FIG. 21 is a diagram illustrating a memory system according to example embodiments.

Referring to FIG. 21, a memory system 1600 includes a memory controller 100, a first memory module 200, a second memory module 300 and a third memory module 400 that are mounted on a base substrate 101.

In comparison with the memory system 1000 of FIGS. 1A and 1B, the fourth memory module 500 may be omitted in the memory system 1600 of FIG. 21. In the memory system 1600 of FIG. 21, the first memory module group may include the first and third memory modules 200 and 400, and the second memory module group may include the second memory module 300. Data lines in the first memory bus 210 may maintain the point-to-point connection between the memory controller 100 and the first memory module 200. Date lines in the second memory bus 310 may maintain the point-to-point connection between the memory controller 100 and the second memory module 300. Date lines in the third memory bus 410 may maintain the point-to-point connection between the first memory module 200 and the third memory module 400. As such, the memory system according to example embodiments may be implemented although the number of memory modules included in the memory system is smaller than four.

In example embodiments, if each memory module is the ×64 DIMM, the memory system 1600 may have the structure of “×32 per DIMM” and a structure of “3DPC.”

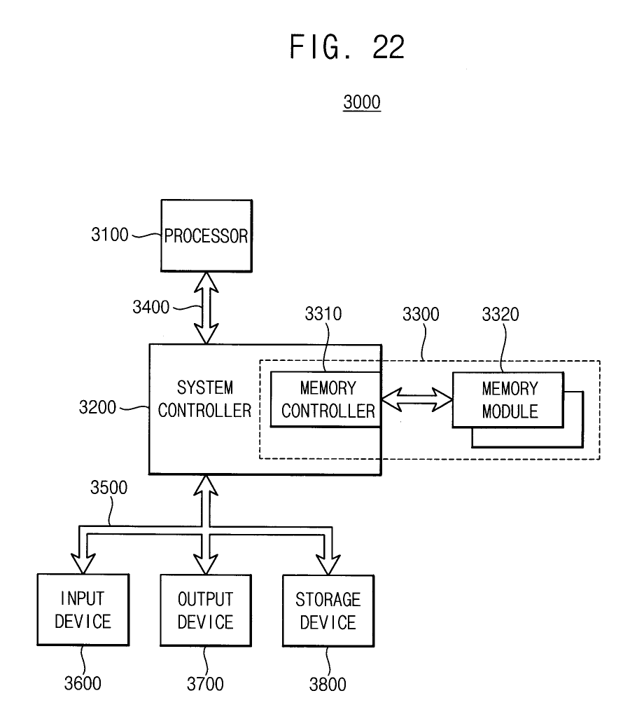

FIG. 22 is a block diagram illustrating a computing system according to example embodiments.

Referring to FIG. 22, the computing system 3000 includes a processor 3100, a system controller 3200 and a memory system 3300. The computing system 3000 may further include a processor bus 3400, an extension bus 3500, an input device 3600, an output device 3700, and a storage device 3800. The memory system 3300 may include at least one memory module 3320, and a memory controller 3310 for controlling the memory module 3320. The memory controller 3310 may be included in the system controller 3200.

The processor 3100 may perform various computing functions, such as executing specific software for performing specific calculations or tasks. For example, the processor 3100 may be a microprocessor, a central process unit (CPU), a digital signal processor, or the like. The processor 3100 may be coupled to the system controller 3200 via the processor bus 3400 including an address bus, a control bus and/or a data bus. The system controller 3200 may be coupled to the expansion bus 3500, such as a peripheral-component-interconnect (PCI) bus. The processor 3100 may control the input device 3600, such as a keyboard, a mouse, the output device 3700, such as a printer, a display device, and the storage device 3800, such as a hard disk drive, a compact disk read-only memory (CD-ROM), a solid state drive (SSD).

The memory controller 3310 may control the memory module 3320 to perform a command provided form the processor 3100. The memory module 3320 may store data provided from the memory controller 3310, and may provide the stored data to the memory controller 3310. The memory system 3300 may be one of the memory system 1000 of FIGS. 1A and 1B, the memory system 1100 of FIGS. 12A and 12B, the memory system 1200 of FIG. 16, the memory system 1300 of FIG. 17, the memory system 1400 of FIGS. 18A and 18B, the memory system 1500 of FIGS. 19A and 19B, and the memory system 1600 of FIG. 21. In the memory system 3300, data lines in some memory buses may maintain the point-to-point connection between the memory controller and some memory modules that are directly connected to the memory controller, and data lines in the other memory buses may maintain the point-to-point connection between the some memory modules and the other memory modules that are indirectly connected to the memory controller. In addition, the plurality of data that are simultaneously provided may be divided into at least two data groups, the memory modules may be divided into at least two memory module groups, and each data group may be stored in or read from a selected memory module of each memory module group. Thus, the memory system 3300 may have relatively high data storage capacity, and the plurality of data may be effectively stored in or read from the memory modules.

The computing system 3000 may be applicable to a desktop computer, a notebook, a computer, a work station, a handheld device, or the like.

The above-described embodiments may be applied to a memory system, and an electronic system having the memory system. For example, the electronic system may be a system using the memory system, e.g., a desktop computer, a laptop computer, a tablet computer, a mobile phone, a smart phone, a music player, a PDA, a PMP, a digital television, a digital camera, a portable game console, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A memory system, comprising:
a memory controller;
a first memory module directly connected to the memory controller through a first memory bus, and configured to exchange first data of a plurality of data with the memory controller through the first memory bus;
a second memory module directly connected to the memory controller through a second memory bus, and configured to exchange second data of the plurality of data with the memory controller through the second memory bus, the second data being different from the first data;
a third memory module connected to the first memory module through a third memory bus, and configured to exchange the first data with the memory controller through the first memory bus and the third memory bus; and
a fourth memory module connected to the second memory module through a fourth memory bus, and configured to exchange the second data with the memory controller through the second memory bus and the fourth memory bus.

2. The memory system of claim 1, further configured to select one of the first and third memory modules as a first selected memory module based on a selection signal, and to select one of the second and fourth memory modules as a second selected memory module based on the selection signal,
wherein the memory system is configured to store first write data of write data in the first selected memory module and store second write data of the write data in the second selected memory module during a write operation mode, wherein the second write data is different from the first write data, and
wherein the memory system is configured to read first read data of read data from the first selected memory module and read second read data of the read data from the second selected memory module during a read mode, wherein the second read data is different from the first read data.

3. The memory system of claim 2, configured so that a first unselected memory module and a second unselected memory module are disabled based on the selection signal, the first unselected memory module being the other one of the first and third memory modules, the second unselected memory module being the other one of the second and fourth memory modules.

4. The memory system of claim 1, wherein the first memory module includes:
a plurality of first data input/output (I/O) pins connected to the first memory bus;
a plurality of second data I/O pins connected to the third memory bus; and
a volatile memory device connected to the plurality of first data I/O pins and the plurality of second data I/O pins,
wherein the memory system is configured to select between the volatile memory device exchanging the first data with the memory controller through the first bus and the plurality of first data I/O pins, and transmitting the first data from one of the memory controller and the third memory module to another one of the memory controller and the third memory module through the first memory bus, the plurality of first data I/O pins, the volatile memory device, the plurality of second data I/O pins and the third memory bus.

5. The memory system of claim 4, wherein the first memory module further includes a plurality of data I/O buffer units, each data I/O buffer unit has a first path and a second path, a first path indicates a path between one of the first data I/O pins and a memory core included in the volatile memory device, a second path indicates a path between the one of the first data I/O pins and one of the second data I/O pins,
wherein one of the first path and the second path is selectively enabled.

6. The memory system of claim 5, wherein each data I/O buffer includes:
a first buffer unit connected to the one of the first data I/O pins;
a second buffer unit connected to the memory core;
a third buffer unit connected to the one of the second data I/O pins; and
a path selection unit configured to connect one of the second buffer unit and the third buffer unit to the first buffer unit based on a selection signal.

7. The memory system of claim 6, wherein another one of the second buffer unit and the third buffer unit that is not connected to the first buffer unit is disabled based on the selection signal.

8. The memory system of claim 1, wherein a distance between the memory controller and the second memory module is longer or shorter than a distance between the memory controller and the fourth memory module.

9. The memory system of claim 1, further comprising:
a fifth memory module connected to the third memory module through a fifth memory bus, and configured to exchange the first data with the memory controller through the first memory bus, the third memory bus and the fifth memory bus.

10. The memory system of claim 9, further comprising:
a sixth memory module connected to the fourth memory module through a sixth memory bus, and configured to exchange the second data with the memory controller through the second memory bus, the fourth memory bus and the sixth memory bus.

11. The memory system of claim 1, further comprising:
a fifth memory module directly connected to the memory controller through a fifth memory bus, and configured to exchange third data of the plurality of data with the memory controller through the fifth memory bus, the third data being different from the first data and the second data;
a sixth memory module directly connected to the memory controller through a sixth memory bus, and configured to exchange fourth data of the plurality of data with the memory controller through the sixth memory bus, the fourth data being different from the first data, the second data and the third data;
a seventh memory module connected to the fifth memory module through a seventh memory bus, and configured to exchange the third data with the memory controller through the fifth memory bus and the seventh memory bus; and
an eighth memory module connected to the sixth memory module through an eighth memory bus, and configured to exchange the fourth data with the memory controller through the sixth memory bus and the eighth memory bus.

12. The memory system of claim 1, wherein the memory controller and the first, second, third and fourth memory modules are mounted on a base substrate,
wherein the first, second, third and fourth memory buses are provided such that a plurality of data lines that are formed on the base substrate are selectively electrically opened or shorted.

13. A memory system, comprising:
a memory controller;
a first memory bus configured to connect the memory controller to a first memory module, and to transmit first write data to the first memory module;
a second memory bus configured to connect the memory controller to a second memory module, and to transmit the second write data to the second memory module, the second write data being different from the first write data, wherein the memory system is configured to simultaneously transmit the first write data and the second write data from the memory controller;
a third memory bus configured to connect the first memory module to a third memory module, and to transmit the first write data received via the first memory bus to the third memory module; and
a fourth memory bus configured to connect the second memory module to a fourth memory module, and to transmit the second write data received via the second memory bus to the fourth memory module.

14. The memory system of claim 13, further configured to transmit first read data to the memory controller through the first memory bus when the first read data is stored in the first memory module, and to transmit the first read data to the memory controller through the first memory bus and the third memory bus when the first read data is stored in the third memory module, and
further configured to transmit second read data to the memory controller through the second memory bus when the second read data is stored in the second memory module, and to transmit the second read data to the memory controller through the second memory bus and the fourth memory bus when the second read data is stored in the fourth memory module, the second read data being different from the first read data, wherein the memory system is configured so that the memory controller simultaneously receives the first read data and the second read data.

15. A memory system, comprising:
a controller;
a first memory module including at least a first memory device having a first memory core;
a first bus between the controller and the first memory module;
a second memory module including at least a second memory device having a second memory core; and
a second bus between the first memory module and the second memory module,
wherein:
the first bus is selectively electrically connected to the second bus; and
the first bus is selectively electrically connected to the first memory core.

16. The memory system of claim 15, further comprising:
a third memory module including at least a third memory device having a third memory core;
a third bus between the controller and the third memory module;
a fourth memory module including at least a fourth memory device having a fourth memory core; and
a fourth bus between the third memory module and the fourth memory module.

17. The memory system of claim 16, wherein:
the controller is connected to each of the first memory module and the third memory module in a point-to-point manner;
the first memory module is connected to the second memory module in a point-to-point manner; and
the third memory module is connected to the fourth memory module in a point-to-point manner.

18. The memory system of claim 16, wherein:
the memory system is configured so that:
the controller transmits data directly to the first memory module and transmits data directly to the third memory module; and
the controller transmits data to the second memory module through the first memory module, and transmits data to the fourth memory module through the third memory module.

19. The memory system of claim 18, wherein:
the memory system is further configured so that:
the controller transmits data directly to the first memory module and simultaneously transmits data directly to the third memory module; and
the controller transmits data indirectly to the second memory module and simultaneously transmits data indirectly to the fourth memory module.

20. The memory system of claim 19, wherein:
the memory system is further configured so that:
the controller receives data directly from the first memory module and simultaneously receives data directly from the third memory module; and
the controller receives data indirectly from the second memory module and simultaneously receives data indirectly from the fourth memory module.
